(19) United States
(12) Patent Application Publication
(10) Pub. No.: US 2025/0200680 A1
(43) Pub. Date: Jun. 19, 2025

(54) AGGREGATION AND TRANSFER OF PROPERTY DATA

(71) Applicant: Invisible Holdings LLC, Sheridan, WY (US)

(72) Inventors: Raymond Francis St. Martin, Felton, CA (US); Andrew Lee Van Valer, Reno, NV (US)

(21) Appl. No.: 18/977,930

(22) Filed: Dec. 12, 2024

Related U.S. Application Data
(60) Provisional application No. 63/609,624, filed on Dec. 13, 2023.

(51) Int. Cl. G06Q 50/16

(52) U.S. Cl. CPC G06Q 50/167

(57) ABSTRACT

Parameters associated with the property are determined. The parameters include fixed geographic location coordinates associated with the property. Modifications to the property are tracked over time based on private information and public information associated with the property. The transferrable digital asset associated with the property is generated. The digital asset includes the parameters of the property and the modifications to the property. An arrangement of the parameters and of the modifications is output.

### CROSS-REFERENCE TO RELATED APPLICATIONS

The present application claims the priority benefit of U.S. Provisional Patent Application No. 63/609,624, filed on Dec. 13, 2023, entitled “AGGREGATION AND TRANSFER OF REAL ESTATE DATA,” the disclosures of which is all incorporated herein by reference in its entirety.

### FIELD OF THE DISCLOSURE

The present disclosure is generally related to generating transferrable objects associated with property, and more particularly to data aggregation, unique object definition, historical stories generation based upon a plurality of data sources and inputs, and transferring ownership of the generated transferrable objects.

### BACKGROUND

Ensuring the accuracy and completeness of property data is crucial for a smooth transfer of property and land ownership. Discrepancies or errors in property records, such as incorrect property boundaries, land coordinates, inaccurate descriptions, or missing documents, can lead to disputes and legal complications. Effective data management systems and diligent verification processes are desired to maintain reliable and up-to-date information about the properties being transferred.

Property data is often collected and stored in various formats and systems by different parties, such as property agents, title companies, and government agencies. Integrating and consolidating these diverse datasets can be challenging, especially when there are inconsistencies or incompatibilities between the systems. Standardization of data formats, establishing data sharing agreements, and utilizing technology solutions that facilitate seamless data integration are desired to overcome these hurdles.

Determining ownership and rights over real property data can be a complex issue. Multiple parties, including land owners, property owners, real property agents, government entities, and third-party service providers, may have rights and interests in the data collected during the land and/or property transfer process. Clarifying data ownership, establishing data usage agreements, and addressing property concerns are desired to ensure the fair and lawful transfer of real property data between parties.

### SUMMARY

Examples of the present technology include a method, a system, and a non-transitory computer-readable storage medium for generating a transferrable digital asset associated with real property. Parameters associated with the real property are determined. The parameters include fixed geographic location coordinates associated with the real property. Modifications to the real property are tracked over time based on private information and public information associated with the real property. The transferrable digital asset associated with the real property is generated. The digital asset includes the parameters of the real property and the modifications to the real property. An arrangement of the parameters and of the modifications is output.

In some examples, a method for generating a transferrable digital asset associated with property includes determining parameters associated with the property. The parameters include fixed geographic location coordinates associated with the property. The method includes tracking modifications to the property over time based on private information and public information associated with the property. The method includes generating the transferrable digital asset associated with the property. The digital asset includes the parameters of the property and the modifications to the property. The method includes outputting an arrangement of the parameters and of the modifications.

In some examples, a system for generating a transferrable digital asset associated with property includes a memory and a processor that executes instructions in memory. Execution of the instructions by the processor causes the processor to perform operations. The operations include determining parameters associated with the property. The parameters include fixed geographic location coordinates associated with the property. The operations include tracking modifications to the property over time based on private information and public information associated with the property. The operations include generating the transferrable digital asset associated with the property. The digital asset includes the parameters of the property and the modifications to the property. The operations include outputting an arrangement of the parameters and of the modifications.

In some examples, a non-transitory computer-readable storage medium, having embodied thereon a program executable by a processor to perform a method for generating a transferrable digital asset associated with property. The method includes determining parameters associated with the property. The parameters include fixed geographic location coordinates associated with the property. The method includes tracking modifications to the property over time based on private information and public information associated with the property. The method includes generating the transferrable digital asset associated with the property. The digital asset includes the parameters of the property and the modifications to the property. The method includes outputting an arrangement of the parameters and of the modifications.

### BRIEF DESCRIPTION OF THE DRAWINGS

FIG. 1 is a block diagram illustrating an architecture of a property story generator system, according to some examples.

FIG. 2 illustrates an exemplary source database.

FIG. 3 illustrates an exemplary event database.

FIG. 4 illustrates an exemplary location database.

FIG. 5 illustrates an exemplary subject database.

FIG. 6 is a flowchart illustrating an exemplary function of a server system.

FIG. 7 is a flowchart illustrating an exemplary function of a data collection module.

FIG. 8 is a flowchart illustrating an exemplary function of a subject module.

FIG. 9 is a flowchart illustrating an exemplary function of an event module.

FIG. 10 is a flowchart illustrating an exemplary function of a location module.

FIG. 11 is a flowchart illustrating an exemplary function of a perspective module. FIG. 12 is a flowchart illustrating an exemplary function of a transfer module.

FIG. 13 illustrates a process for generating a transferrable digital asset associated with real property in accordance with one embodiment.

FIG. 14 is a block diagram illustrating an example of a machine learning system.

### DETAILED DESCRIPTION

Many of the embodiments described herein are described in terms of sequences of actions to be performed by, for example, elements of a computing device. It should be recognized by those skilled in the art that specific circuits can perform the various sequence of actions described herein (e.g., application-specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present technology may be embodied in several different forms, all of which have been contemplated to be within the scope of the claimed subject matter. In addition, for each of the embodiments described herein, the corresponding form of any such embodiments may be described herein as, for example, a computer configured to perform the described action.

One skilled in the art will appreciate that the present disclosure may refer to “land” and “property,” terms that have distinct meanings, yet are interrelated. Land existed before it became property, and without land, there can be no real property. Land is defined as the earth's surface extending downward to the center of the earth and upward to infinity, inclusive of everything permanently attached by nature, such as boulders, trees, water, and minerals below the earth's surface. In contrast, real property encompasses the land at, above, and below the earth's surface, including everything permanently attached to it, whether natural or artificial, such as streets, utilities, sewers, fences, and buildings. What distinguishes land as property is the existence of a title and various contracts, signifying true ownership rights, which may be, for example, defined, enforceable and protected ownership rights. The coordinates defining the land can be represented through various options such as geographical coordinates, survey data, or mapping systems as per the requirement of the system. These coordinates define the specific latitude and longitude, marking the boundaries and precise location. Property, a broader term than real property, includes the interests, benefits, and rights inherent in ownership, encompassing not only the physical land (surface, what lies below, and above it) but also everything permanently attached to it, whether natural or artificial. Furthermore, property encompasses all rights of ownership, including the right to possess, sell, lease, and enjoy the land. The subject matter described herein may pertain to a defined jurisdiction, specific area, topographical features, plurality of structures, various utilities, legal aspects such as zoning regulations and easements, environmental considerations, and improvements or modifications related to the land or real estate. Additionally, the description may articulate how the land or property is particularly suited to or involved in a specific technologies, processes, and/or methodologies detailed in the patent application. The understanding of the distinctions and relationships between land and property, as defined above, is integral to the present disclosure.

Aspects of the present disclosure provide effective data management systems and diligent verification processes to maintain reliable and up-to-date information about the properties being transferred. Additionally, the present disclosure provides standardization of data formats, establishing data sharing agreements, and utilizing technology solutions that facilitate seamless data integration are desired to overcome these hurdles. Furthermore, the present disclosure clarifies data ownership, establishes data usage agreements, and addresses property concerns to ensure the fair and lawful transfer of real property data between parties.

In the physical world, real property refers to tangible, immovable property consisting of land and anything permanently affixed to it, such as buildings, houses, and property features. Real property also exists in virtual worlds. To avoid confusion, this disclosure may also refer to real property in virtual environments as virtual property. In virtual worlds, virtual property refers to digital spaces that exist within online environments such as virtual reality platforms, video games, or the metaverse. Like its physical counterpart, virtual property can be bought, sold, leased, or developed. This can include anything from spaces for advertisements in a digital city, plots of land in a virtual reality game, or even entire digital worlds mimicking the real world, invented, or conceptualized.

The value of physical real property and virtual property are also similar. There are different financial metrics and data that are used in assessing and valuing both physical and virtual/digital real property that is well known. In both the physical and virtual world there are other methods that are just as important to the individual or business in the story of valuing real property. For example, in the physical world the location, atmosphere, aesthetics, lifestyle suitability, emotional memories, historical or unique features, condition of property, aspects of the land, safety aspects of a property can significantly influence its perceived value. Virtual property in the virtual world can be driven by factors such as the popularity of the platform, location within the virtual space, the size of the virtual property, and its potential for digital development or revenue generation. The present disclosure may describe many concepts based on real property. However, one of ordinary skill in the art would understand that the concepts of the present disclosure are applicable to both real property and virtual property.

Brand ownership and management are of great importance to real property developers, real property investors, architects, builders, material suppliers, franchises, educational institutions, and government agencies.

Brand ownership and management and brand differentiation in an industry is important. Brands serve as valuable assets to their owners, establishing standards of quality, fostering trust and credibility, reflecting their values, and exhibiting numerous other attributes. Brands are owned and managed by developers, developments, investors, government institutions, educational institutions, owners, builders, subcontractors, suppliers, and industry organizations.

Real property properties and geographic land stand as significant anchors in the spectrum of human connections. They are the physical manifestations of our collective progress, bridging gaps between individuals, locations, historical periods, emotions, memories, and cultures. The presence of real property properties and land boundaries in our lives offers insights into our identities and our positioning within the grand scheme of existence—a timeline encompassing the past, present, and future. Each real estate and land location carries with it an origin story, a narrative shaped by who built it, the purpose it served, the events it witnessed, and the era it stems from. Every property and land location has a tale to spin, a tale that embeds it further into our societal fabric.

There was a time when architectural blueprints revolutionized the world of construction, making the transition from manual labor to precision-driven designs. In this age of rapid technological advancement and evolution, properties and geographic land areas are more than just physical constructs and coordinate locations. They are becoming interwoven with personal narratives and context, through the channels of the Internet and the digital landscape. Stories stripped of their properties seem hollow, and properties devoid of their stories lose significance. The merging of stories and properties enriches the experience, transporting the observer from the mundane to the extraordinary.

This brings about the dawn of “Objects+” or as relates to real property, “Land+”, a universal language that isn't confined to a specific audience. It resonates with everyone. Properties and land, once associated and connected with relevant information, are quickly evolving to become the primary mode of articulating and communicating a wide range of concepts—from ideas and information to art, culture, music, sports, literature, and more.

The “Social Identity of Objects (SIO)” emerges as a pivotal framework at this junction. It combines data and information to transcend the limitations of physical properties and land boundaries, adding layers of context and human texture. It liberates properties and land from their mere physicality, fostering a richer, more nuanced understanding of them.

Free from the bounds of isolation, the SIO technology facilitates the seamless association of all pertinent information about a specific property or land boundary. It stands as a valuable resource, a platform for storing, sharing, and exchanging data.

In today's technologically-saturated environment, humans rely on intuitive and emotional references to connect properties, land, events, and cultures. Time and attention are valuable commodities, and as the information overload grows, connections and context become crucial for effective time utilization.

Fast-moving, interconnected, and complex—today's environments demand more intuitive communication tools. The SIO technology platform isn't just an information hub; it's an interactive tool fostering better understanding.

Physical properties and land coordinates, traditionally, are understood as entities existing within the tangible world. The boundary of a property or land may evolve over time, but it possesses a visible or tangible surface with unique properties and land.

Take a house, for example. Its form may typically be rectangular, but the rectangle can possess diverse characteristics—the intricate details of a Victorian house, the minimalistic lines of a modern abode, or the rustic elements of a cabin. The identity of a property or geographic land area, therefore, can change over time, and these changes can be tracked and annotated in real time. The initial identity of a property or land area can morph due to renovations or modifications but can also be enhanced and amplified by the information linked to the property or land itself.

Today, an individual can interact with various devices that facilitate a more comprehensive understanding of the status and context of a real estate. For instance, home automation systems can monitor the working components and efficiency of a house, while property analytics tools can help individuals understand more about their property's market value and performance. Real property properties, now intertwined with technologies from multiple domains, are evolving into more complex structures that provide a richer and more context-aware experience for the user. As this process continues to expand and develop, it's conceivable that every physical property will be identified with a unique internet address, enabling novel ways to experience and interact with physical properties and the events associated with them. These new layers of information surrounding physical properties shape how users interact and bridge the physical and virtual worlds.

With accelerating technological advancements, people will commonly interact with properties and land on a new level in the virtual world via augmented reality (AR) and artificial intelligence (AI) capabilities. Information layers and narratives from various sources will be associated with specific properties and land, events, and developments, enhancing value, engagement, and relationships with these properties and land, essentially creating a mixed reality environment where the real and virtual worlds converge and synchronize. The SIO offers a personalized approach to capturing, analyzing, and displaying data, acknowledging that subjectivity and context can play a crucial role in understanding properties and land, events, societal shifts, and culture.

SIOs presents a novel method for discovering properties and land through a system of relationships, attributes, and context of specific properties or land areas. Searches can be conducted in various ways and can be associated with a single type or choice of different types of searches outlined in this document. The searches can be based on any attributes or relationships of the SIOs within a single database or group of public or private databases.

Search examples might include property type, land coordinates, size, date of construction, date of incorporation, builder, area, and relationships to other SIOs, connecting unlimited associations or attributes attached to each type of registered or non-registered user via a menu driven by choices.

Individual users can deploy unique search criteria based on their specific needs. For example, a potential buyer might wish to see the complete history of a property and land in any possible views—limited, for instance, to publicly available information only. Conversely, an individual might wish to explore the history of a property and land (e.g., a historical building) through associated narratives and memories via a network of private databases.

A property or land developer might want to see the totality of details and attributes of all component materials, transportation, and pricing from the time of property inception or land discovery or purchase. A real property broker might wish to have access to the entire lifecycle of a property, including its effects on the SIO such as feelings, returns, side effects, propensity to purchase again, etc. In one embodiment, the systems and methods described herein can integrate and use narrative history, product lifecycle, and associated technologies and processes.

The internet has experienced a proliferation of data unparalleled in human history. This is especially true in the realm of real property and housing. The terms “data” and “information” are often used interchangeably, but there are subtle differences between the two. Data is essentially “raw information” that can originate in any format as a number, symbol, character, word, code, text, blueprint, house plan, etc. Data can also be analyzed and used to generate/create information that couldn't be obtained by merely observing the data element(s) alone. Information, therefore, is data put into context and utilized and understood in some significant way.

In the context of real property, “information” can include descriptors such as property specifications, market trends, price history, neighborhood data, real property laws, which are transmitted by the act or process of communication. The information can then be roughly summarized as an assemblage of data in a comprehensible form, capable of communication.

Information only begins to embody meaning when presented in context for its receiver. In the world of real property, when information is entered into and stored in an electronic database, it is generally referred to as data. After undergoing processing and retrieval techniques—such as associating property attributes, neighborhood characteristics, housing trends, market factors, and other associated data formatting—output data can then be perceived as useable information and applied to enhance understanding of a property or to make informed decisions.

The most common data types in the real property context include 1.) Quantitative data is numerical data or data that can be expressed mathematically, such as square footage, price, or the number of rooms; 2). Qualitative data cannot be measured, counted, or easily expressed in numerical form. This data originates from text, audio, images, property descriptions, land coordinates buyer reviews, etc. Qualitative data can be felt, described, and shared via data visualization tools, timeline graphics, infographics, and word narratives. 3). Nominal or categorical data is comprised of different categories that cannot be rank-ordered or measured. It is data that is simply used to identify or label a variable, including property type, style, location, etc.; 4). Ordinal data contains values that follow a natural order within a known range. For example, property ratings can be ranked in specific ranges in the order of priority or value but not used for calculating; 5). Discrete data, or categorical data, is divided into separate categories or clearly different groups. Discrete data contains a specific number of values that cannot be subdivided. For example, the number of bathrooms a house has is a discrete data point; 6). Continuous data describes data that is measurable and observable in real-time. It can be measured on a scale or a continuum and further subdivided into finer values, such as the fluctuating prices of properties in a certain neighborhood.

Data processing takes place within a framework or system, divided into three distinct stages: 1). Data is collected, gathered, and/or input from various sources—property and land owners, real property agencies, housing databases, sensors, and individuals. 2). Data is sorted, organized, cleansed, and input into a digital repository, database, or system. 3). Transformed into a suitable format that users can understand and use. Quality data is the primary requirement for transformation into quality information: 1). Data must come from a reliable source; 2). Data should be complete without missing details; 3). Systems must be in place to eliminate duplicated data; 4). Data must add relevance and value to the database to generate meaningful information; 5). Data must be current and timely.

In one embodiment, the systems and methods described herein can integrate multiple data types, quality information, retrieval requirements, and associated technologies and processes, all relevant to the real property and housing sector.

Information is any data that can be collected, formatted, digitized, produced, distributed, understood, deployed, and transmitted to the user/viewer/receiver. While the concept of information is exceptionally broad, in the context of real property, it can include anything from property and land histories, architectural narratives, market trends, neighborhood stories, visual images of properties and land, and multimedia presentations of homes.

While information is virtually unlimited in scope and variety, there are common types or categories of information that are often cited in real property: 1). Sensory information includes information that can be “experienced” by the human senses—the look of a house, the sound of the neighborhood, or the feel of the interior finishes. These “sense information” variants are humans' primary connection to the physical property and land; 2). Biological information includes any information found in the study of living organisms and/or associated processes that can control or be perceived by the body—such as the impact of a house's design on human well-being; 3). Conceptual information or any abstraction that can be experienced apart from physical reality, like the idea of a dream home or the concept of a sustainable building; 4). Imagination information is constructed/conceived in the human mind in the form of an idea or story that can be communicated and used to create new thoughts and ideas—such as the envisioned future of a property or land; 5). Knowledge information includes “factual” information and “know-how” that is specifically designed and intended for human use and application—such as understanding property laws or knowing how to evaluate a property's value or land value; 6). Extended knowledge information can only be generated by human experience and action and not via an instruction manual or book—such as the understanding gained from years of living in a certain neighborhood; 7). Data or that which is specifically designed and utilized in systematic analysis, machine learning, and Artificial Intelligence—for example, a collection of home prices or neighborhood demographics; 8). Knowable unknowns and knowing what is unknown can be valuable information—such as knowing what we don't yet understand about a land or property's history; 9). Intelligence is the ability to build upon known information and create new meaning and connectivity with objects and emotions, cultures, and events—such as interpreting a land or property's value in the context of current market trends; 10). Misinformation is information that is wrong or incorrect—like faulty data on a or land property listing; 11). Disinformation is the deliberate distribution of “propaganda” designed to advocate for a specific message or agenda—often including a negative social context; 12). Situational information directly connected to a specific situation cannot be separated from its context—like understanding a property's value in the context of a market crash; 13). Dispersed knowledge is information that exists in multiple locations/areas and not simply in one place—for example, understanding a neighborhood's character from various viewpoints will form uniquely dispersed knowledge; 14). Asymmetric information includes information of “superior” value to comparable information—for instance, a real property agent may have critical information on a property that enables better transaction decisions.

In one embodiment, the systems and methods described herein can integrate multiple information types, collected, formatted, digitized, distributed, and associated technologies and processes, all of which are pertinent to the real property sector.

SIO utilizes eight specific data search view techniques in its system framework or what is called “Smart Label Views/Search” to access data and transform it into usable information. The first is the holistic view. A holistic view refers to the complete data set “picture” of a property, land, or housing market. Gaining this comprehensive view requires looking at the data throughout its entire lifecycle—from the moment a property is built until the information is needed by an individual at the current moment of retrieval.

The holistic data approach is designed to improve data analysis and integration by enabling information to be distributed across multiple platforms and systems efficiently and consistently. The first component of the holistic data process includes data collection—assembling information from a variety of sources, both public and private. Data collection can be compiled and identified from structured, semi-structured, and unstructured sources, including operational systems (i.e., real property databases, financial systems), website information, social media, and user-supplied narratives and stories about properties and land. The second component includes data integration and transformation, coalescing disparate data from multiple sources into an easily accessed and usable database(s). These integrated data and information assets provide the foundation for seamless and rapid access by end-users. Data integration and transformation rely on data quality, consistency, and control. The SIO solution provides processes that are repeatable, automated, and scalable to meet future user demand.

Third, presenting holistic data in a meaningful format(s) when requested, maintaining and supplementing data within a structural framework related to real property and housing, increasing in value over time, will remain a source of evolving relevance to users. Presentation techniques can uncover key metrics, trends, and exceptions in housing market data and offer customized and unique visualizations of property or land details.

Fourth, maintaining data quality and consistency is critical for the long-term viability of holistic data in the real property sector. SIO will deploy tactics including identifying data quality thresholds, fraud alerts related to property or land transactions, audit report functionality, and robust data governance protocols for property data. All SIO master data repositories and data privacy strategies will be applied to all users in the real property field.

In one embodiment, the systems and methods described herein can integrate and use holistic data technologies and processes within the real property industry.

The humanistic view of data or human-centric approach is intended to provide personalized experiences for the user, offering a revolutionary future for data visualization in real property. Unlike the traditional methodology where questions are asked, and answers are found, the humanistic view of data is contextual or related to a specific property, housing market circumstance, event, or relationship. Data views are transformed into visual representations in this process, adding considerable substance and context to the experience.

SIO technology will leverage information from people with a personal connection to specific properties, real property events, and housing cultures. This human-centered approach to the origination, management, and interpretation of data provides value and importance for the people it came from and other people it will benefit from. SIO will create a trusted relationship strengthened by transparency within its system framework.

SIO is implementing a personal approach to how data is captured, analyzed, and displayed in the real property sector, realizing that subjectivity and context can play a defining role in understanding properties, housing market trends, social changes, and culture. A human-centric approach to data has the greatest potential for impact when going beyond gathering data to create personalized commercial/residential experiences. SIO will deploy its technology to understand the values and needs of people in the larger context of their housing lives.

In one embodiment, the systems and methods described herein can integrate and use human-centric data technologies and processes within the housing sector.

Chronological, historical, or timeline view data, broadly considered, is collected about past events and circumstances about a particular property, information set, or housing market matter. Historical data includes most data generated manually or automatically and tracks data that changes or is added over time, such as property values and neighborhood trends. Historical data offers a vast array of use possibilities relating to properties, narratives, cultural events, housing projects and product documentation, conceptual, procedural, empirical, and objective information, to name a few.

With increased cloud computing and storage capacities, data collection and retrieval allow for more data stored for greater periods with access by more users in the real property sector. Since data storage does require resources and maintenance, data life cycle management (DLM) can ensure that rarely referenced data, such as old property records, can be archived and accessed only when needed.

Data preservation is essential and provides users with 1.) the ability to understand the past of a property or housing market; 2.) a deeper understanding of the evolution of patterns and information over time, providing insights and new perceptions about properties, real property events, and information. 3.) Enable possible future assessments about housing cultures, aesthetics, symbols, social interaction, and systems.

Historical data collections can originate from individuals using laptops, smartphones, tablets, or other connected devices to interact with real property platforms. Data can be captured via smartphone cameras, collected via sensors, satellites, and scanners, micro-chips, and massive arrays. There is no digital object or system that is not within the scope of digital preservation in the real property sector. Digital technologies are a defining feature of our age and have become the core commodity for industry, commerce, and government in housing, research, law, and cultural heritage. The future of real property will hinge on reliable access to digital materials while families and friends extend and sustain their relationships through digital interactions with properties and their history. The more society depends on the importance of digital materials and history in real property, the greater the need for preservation and access by future generations and shared collaboration. In some examples, the systems and methods described herein can integrate and use chronological/historical data views and timelines and associated technologies and processes.

Data cluster view techniques are based on similarities among data points in the real property market. Data clusters show which properties or housing market trends are closely related, so the housing data set can be structured, retrieved, analyzed, and understood more easily.

Data clusters are a subset of a larger dataset in which each data point, such as a property, is closer to the cluster center than to other cluster centers in the housing dataset. Cluster “closeness” is determined by a process called cluster analysis. Data clusters can be complex or simple based on the number of variables in the group, such as property features or housing market indicators.

Clustered data sets occur in abundance in the real property sector because all the events we experience, like property transactions or housing market fluctuations, have measurable durations. It, therefore, follows that the individual data points associated with each instance of such an event are clustered with respect to time. Many events associated with clustered data in real property can be highly significant, and it is important to identify them as accurately as possible.

Clustering is deployed for high-performance computing in the real property sector. Since related data, such as property details or housing market trends, is stored together, the related data can be accessed more efficiently. Cluster views deliver two advantages in the housing sector: efficiency of information retrieval and reducing the amount of space required for digital storage. Information related and frequently requested, such as specific property details, is ideal for cluster viewed data requirements.

In one embodiment, the systems and methods described herein can integrate clustered view data technologies and processes within the real property industry.

Data visualization is a methodology by which the data in raw format, such as raw housing data, is portrayed to reveal a better understanding and provide a meaningful way of showcasing volumes of data and information related to real property. Various methods of data visualization and viewing options can be deployed for various purposes and information sets in the housing sector, including but not limited to: Property views, Neighborhood views, sentimental views, significance views, monetary/financial views, consumer views, real property market views, and social views, among others.

The system that asks the “right questions” about housing and real property will generate information that forms the foundations of choosing the “right types” of visualization required. Presenting housing information and narratives into context for the viewer provides a powerful technique that leads to a deeper understanding, meaning, and perspective of the information being presented.

A clear understanding of the audience will influence the visualization format types in the real property sector and create a tangible connection with the viewer. Every data visualization format and narrative related to housing may be different, which means data visualization types will be fluid and ultimately change based on goals, aims, objects, or topics. Presentation technologies are becoming increasingly dynamic, and by better understanding user-based preferences, individual housing stories can be accurately portrayed.

In one embodiment, the systems and methods described herein can integrate multiple data visual format technologies and processes within the real property industry.

A hierarchical data view is defined as a set of data items related to each other by categorized relationships and linked to each other in parent-child relationships in an overall “property tree” structure. When information needs to be retrieved, the whole tree is scanned from the root property down. Modern databases have evolved to include the usage of multiple hierarchies over the same data for faster, easier searching and retrieval of property data.

The hierarchical structure of data is important in the real property sector as the process of property data input, processing, retrieval, and maintenance is an essential consideration. An example would include a catalog of properties, each within specific categories such as residential, commercial, or industrial, with further subcategories like single-family homes, condos, or apartments in the residential category.

The hierarchical database model offers several advantages in the real property industry, including but not limited to 1). The ability to easily add and delete new property information; 2). Property data at the top of the hierarchy can be accessed quickly via explicit table structures; 3). Efficient for linear property data storage applications; 4). It supports systems that work through a one-to-many relationship in the real property sector; 5). It's a proven storage and retrieval model for large property data sets; 6). Promotes data sharing in the real property sector; 7). A clear chain of authority and security. In one embodiment, the systems and methods described herein can integrate hierarchical database models, technologies, and processes.

A spherical data view is a form of non-linear data in which observational data related to the real property market are modeled by a non-linear combination model relying on one or more independent variables. Non-linear methods typically involve applying some type of transformation to the housing input dataset. After the transformation, many techniques can then be tried to use a linear method for property classification.

Data credibility is a major focus implemented to ensure that real property databases function properly and return quality data and accurate housing information to the user. In the SIO system for real property, a weighted average technique of ensuring data quality can be utilized and includes processing a collection of each of the data attributes such as property location, type of property, property history, current, and past relationships with other properties, and many others to determine the credibility of the SIO data. For example, a search for a property in a certain location might include information relating to neighborhood, house type, price, compliance with regulations, and its status. This process evaluates the average of a housing data set, recognizing (i.e., weighing) certain information as more important than others.

Verifying data integrity is an extremely important measure in the housing market since it establishes a level of trust a user can assign to the property information returned and presented. Credible data can only be assured when robust data management and governance are incorporated into the system. Satisfying the requirements of intended users and associated applications will ensure the highest quality data, including but not limited to 1). Accuracy from data input through property data presentation; 2). Exceptional database design and definition to avoid duplicate property data and source verification; 3). Data governance and control; 4). Accurate data modeling and auditing; 5). Enforcement of data integrity; 6). Integration of property data lineage and traceability; 7). Quality assurance and control.

In one embodiment, the systems and methods described herein can integrate spherical data views and data credibility control technologies and processes within the real property sector.

A framework in computer programming is a structure used as a base environment or foundation upon which programmers and developers create software applications deployed on a specific platform(s), such as real property databases. Frameworks are designed to be versatile, robust, and efficient, offering a collection of software tools and services that eliminate low-level and repetitive processes, allowing developers to focus on the high-level functionality of the housing application itself.

A blockchain framework provides a unique data structure in the context of computer programming, consisting of a network of databases/virtual servers connected via many distinct user devices. Whenever a contributor in a blockchain adds data, such as a real property transaction, it creates a new “block,” which is stored sequentially, thereby creating the “chain.” Blockchain technology enables each device to verify every modification of the blockchain, becoming part of the real property database and creating an exceptionally strong verification process.

Security provided by this distributed ledger/data process is among the most powerful features of blockchain technology, especially for housing transactions. Since each device holds a copy of these ledgers, the system is extremely difficult to hack—if an altered block is submitted on the chain, the hash or the keys along the chain are changed. The blockchain provides a secure environment for sharing real property data and is increasingly used in many industries, including real property.

Blockchains can be divided into public, private, and hybrid, and can be managed differently by network participants. They offer different degrees of accessibility and control and are increasingly utilized in the real property sector for secure, traceable transactions. Blockchain technology is a novel and disruptive technology and can accommodate highly scalable applications such as large, complex real property databases. In one embodiment, the systems and methods described herein can integrate computer programming and blockchain technologies and processes.

Blockchain security and cryptographic protocols make this technology increasingly attractive for business models and applications in real property where provenance and authenticity are critical. While blockchain is well-known for applications in the cryptocurrency world, it is becoming an essential component of applications for non-fungible tokens (NFT) in the housing market.

If a real property asset is fungible—it is interchangeable with an identical item—NFTs, on the other hand, are unique and non-interchangeable units of data stored on a blockchain—therefore, one NFT for a property is not equal to another. NFTs can be associated with reproducible digital files such as photos, housing blueprints, property narratives, videos, and audio. The possibilities for NFTs within the blockchain framework are virtually endless in the real property sector because each NET is unique yet can evolve over time. The value of NFTs is in their “uniqueness” and ability to represent physical properties in the digital world.

Once an NFT for a property is created, it is assigned a unique identifier that assures authenticity and originality. Each NFT is unique, so all the information about the token is stored on the blockchain—meaning if one “block” in the chain fails, information will still exist on another block, ensuring the NFT remains safe and secure indefinitely.

The unique capabilities of blockchain technology coupled with NFTs guarantee the authenticity, originality, and longevity of real property properties. With blockchain technology, it is impossible to copy or reproduce an NFT, and ownership is recorded in an unalterable way.

Tracking and exchanging real-world assets like houses in the blockchain can assure that the asset has not been duplicated or fraudulently altered. NFTs are not limited to purely digital items, but digital versions of real property properties can be attached to specific narratives and stories. Unlike digital media, represented by codes and numbers—properties are separate entities that can carry intuitive connections.

For instance, human memories can be connected to a physical property providing meaning and context for the viewer. A childhood home may be linked with a story that can transport the viewer back to a childhood experience—not necessarily connected to any monetary value but a narrative memory wrapped within the property itself. Narratives can be associated with anything, from a family home passed from one generation to the next or a favorite vacation house. We are a society that collects “properties,”—and these properties all have unique meaning and context.

An innovative example of this technology is occurring in preservation of historical properties. Collecting and preserving historical housing data, objects, and associated narratives allow communities to interact with historical and culturally relevant houses in unique and novel ways. These properties communicate with the viewer through the memories we associate with them. Global historical events and properties are inextricably linked to personal histories.

The lines of separation between the digital and physical worlds are converging—as virtually any property can be connected to the Internet. Enhanced programming platforms, sensors, AI, Augmented reality, intuitive applications, and increased bandwidth capabilities will make “connected properties” more useful and interactive. As information proliferates, the power to connect stories with properties will shape wisdom, culture, and future generations.

In one embodiment, the systems and methods described herein can integrate non-fungible tokens (NFT) technologies and processes in the real property market. Some embodiments of this disclosure, illustrating its features, will now be discussed in detail. It can be understood that the embodiments are intended to be open-ended in that an item or items used in the embodiments is not meant to be an exhaustive listing of such items or items or meant to be limited to only the listed item or items.

“Historocity” or “Historacity,” as defined by the inventors herein, is a specialized metric designed to quantify the aggregated historical value of an artifact, or a collection thereof. Unlike the traditional concept of historicity, which is limited to the verification and authentication of historical events, characters, or phenomena, Historocity expands the scope to include three additional dimensions: popularity, trust or certification, and value associated with objects. Popularity is measured by the level of public attention an artifact or its associated elements have garnered over time, through public mentions, scholarly references, or social interactions. Trust or certification quantifies the level of confidence in the provenance or authenticity of the artifact, established through expert opinions, credentials, or documented evidence. The value associated with objects allows for comparison of other similar objects across many domains, monetary value being the most obvious. For example, two nearly identical baseballs may sell for entirely different orders of magnitude based on the stories told about them, e.g., a slightly used baseball may sell at a yard sale for $2 after a member of the household has lost interest in the sport, compared to Mark McGwire's No. 70 in 1998 baseball, which sold for $3 million. The calculation of Historocity integrates these multidimensional data points to produce a composite value that can be represented numerically or categorically. In some instances, this value is further refined by integrating social or sentimental factors, yielding an even more comprehensive value termed “Aggregated Historocity.” This aggregated value not only serves as a holistic measure of the artifact's historical significance but also holds transactional utility. It can be sold, transferred, willed, or loaned either independently of the physical artifact or in conjunction with it. Historocity provides a robust framework for evaluating the comprehensive historical significance of artifacts and collections, offering utility for curators, researchers, and collectors alike.

The Social Identity of Objects and their associated Historocity scoring system presents a novel method of determining an object's significance based on a combination of various value systems. Throughout history and across cultures, value systems have continuously evolved to shape human beliefs, behaviors, and decision-making processes. For instance, the perception of time has been universally regarded as a treasured resource, prompting individuals to focus on punctuality and efficiency. Similarly, the value attached to money, and its cultural derivatives like currency, signifies the emphasis on financial stability and prosperity. While these tangible assets possess clear worth, abstract concepts like social and relationship values underscore the importance of interpersonal connections, community bonds, and societal contributions. Historical values emphasize the reverence for past lessons, traditions, and inheritances, whereas personal and intrapersonal values reflect an individual's internal beliefs about self-worth, growth, and potential. Objects can also carry sentimental value, representing emotional bonds, memories, or significant life moments. Spiritual systems provide perspectives on existential beliefs and moral codes, influencing one's view on life's purpose and ethical considerations. Furthermore, in an era of growing environmental consciousness, the significance of preserving our natural surroundings is reflected in environmental values. Lastly, educational value, focusing on the efficacy and relevance of learning experiences, emphasizes the importance of knowledge acquisition and cognitive development. By integrating these multifaceted value systems into the Historocity scoring, the Social Identity of Objects offers a comprehensive, nuanced, and culturally sensitive method to ascertain an object's importance in a given context.

To further expand on the Historocity scoring system in the Social Identity of Objects, other value systems may be considered. Incorporation of emotional value addresses the complex spectrum of human feelings attached to objects or experiences. This encompasses not only positive sentiments like joy and nostalgia but also accounts for potential negative associations. Understanding that our connections with items aren't merely functional but deeply emotional provides a holistic view of an object's significance. Location value accentuates the importance of geographical positioning in determining an object's relevance. Economic and social attributes of a location, combined with factors like access to essential amenities and safety, play a pivotal role in an object's value. This dimension not only provides context but also highlights the dynamic interplay of market forces and socio-economic conditions in shaping perceptions of value. Intrinsic value incorporates a philosophical perspective of the value of an object, emphasizing the inherent worth of an object or entity, irrespective of its market-driven or functional value, this may be especially true when considering human life or other fundamental human values. This provides the concept that certain objects, beings, or environments possess value purely based on their existence or innate qualities outside of any other value system. Spatial value can be considered in terms of, for example, urban planning and architecture, stressing the value derived from specific spatial contexts, e.g., a certain amount of square or cubic footage my have some value regardless of (or despite) its contents. This could be an urban park or a historical site. The worth isn't just aesthetic but also pertains to economic implications, functionality, and broader urban development strategies. Physical value may be tangible metrics on the material properties and performance capabilities of objects.

The Historocity scoring system of the Social Identity of Object may further incorporate or reflect upon various additional value paradigms, including Fiat value, underpinned by government regulation and policy, remains contingent upon macroeconomic trends, political stability, and regulatory decisions, rendering its value both influential and volatile. Conversely, the cryptocurrency value, powered by cryptographic technology such as blockchain, is anchored in decentralized systems and garners its worth from technological trust and its potential to redefine financial structures. Driven by market sentiments, technological evolutions, and regulatory climates, its fluidity mirrors the dynamic nature of digital asset valuation. Adjacently, copyright value provides protection to the value created by creativity and innovation, offering both economic rights and a moral stance to creators. Through licensing and intellectual property management, this value protects and incentivizes originality. The essence of moral value is rooted in the ethical compass guiding societies and individuals. Often universal, and sometimes relativistic based on cultural differences, these principles provide the ethical framework navigating society and life. Similarly, cultural value celebrates the plethora of human expressions, traditions, and practices, emphasizing shared heritages and identities. Regional value underscores the significance of geographical locales, intertwining economic, cultural, and social dimensions. This value promotes local entrepreneurship, strengthens cultural and social assets, and galvanizes community pride. Through regional development endeavors, it perpetually seeks to uplift, innovate, and harness regional potential.

Furthermore, a Historocity scoring system endeavors to incorporate a myriad of value systems, such as, for example human value, which emphasizes the innate worth of every individual, highlighting the significance of human rights, social justice, and overall well-being. Such a system promotes respect, autonomy, and the holistic growth of each individual, free from discrimination. Sustainability value underscores the importance of sustainable practices that balance economic, social, and environmental considerations. The objective of such a value system is to optimize present needs without jeopardizing future generations, emphasizing the reduction of environmental footprints and promoting sustainable development. Business value offers a perspective on the significance of a company's contributions to stakeholders, quantified through financial metrics, market presence, and societal impact. Economic value provides a means to evaluate the worth of goods, services, or assets in a market setting. It not only addresses the demand-supply dynamics and innovation but may also underscore the importance of addressing societal issues and environmental protection. Self-value emphasizes the inherent worth and self-perception an individual possesses, reflecting on their mental well-being and overall life satisfaction. It is intrinsically linked to one's self-image, confidence, and overall life outcomes. Environmental value emphasizes the significance of preserving and valuing the natural environment. Instrumental value provides an estimate of the tangible benefits derived from the environment, signifying the interconnectedness between human well-being and environmental health. Health value focuses on the importance of physical and mental health, which is fundamental for individual well-being and societal progress.

In the SIO network, a Historocity scoring system is introduced to facilitate the exploration and ranking of individual objects and collections. The system computes relative scoring metrics based on multiple value systems, both mentioned and unmentioned. Users can evaluate and order objects or collections in accordance with these metrics, providing flexibility to accommodate any past, present, or future value system for comprehensive object assessment.

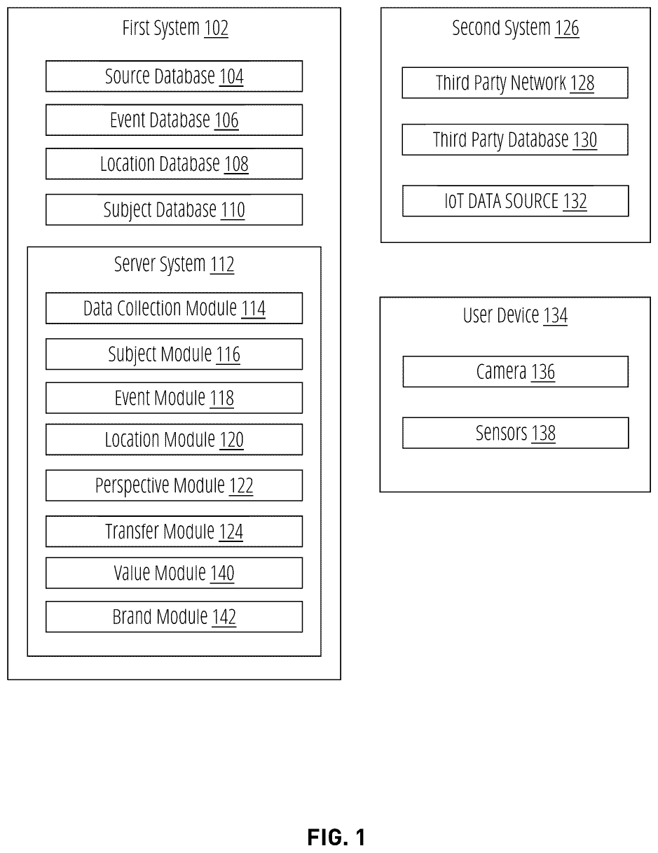

FIG. 1 is a block diagram illustrating an architecture of a property story generator system. The real property story generator system is a system that can organize and manage data and information and associate the data and information with a story associated with property. The data and information can be stored as objects with rich data attributes such as materials used during construction, people associated with the real property, events, etc. These objects can be created and edited by users or automatically by modules. The system also includes references to source materials or source files stored in a source database, which may be, for example, such as individuals providing narratives, recordings, written descriptions, pictorial representations, property documents, news articles, social media posts, digital or physical archives, or academic papers, etc. These sources are used to create and support the building blocks, allowing users to reference the original source file and information originated and how it is continuously related to other objects. As discussed above, the real property story generator system can organize and manage data and information and associate the data and information with stories associated with both real property and virtual property. While the disclosure discusses the presently disclosed concepts in relation to real property, one of ordinary skill in the art would understand that the presently disclosed concepts can be used in relation to both real property and virtual property.

This system comprises a first system 102 that may collect and store a social identity of objects (SIO's), with a focus on properties and real property data. The first system 102 enables instantiation of SIO data for each object in the system, and recommends data based on time, place, space, written tags, photos, videos, descriptions, commonality, architectural style, previous owners, metaphysical, and emotions to be displayed through an interface, among other functions. The first system 102 may further be used to assess and verify the accuracy of an object, property, or story which may be comprised of one or more objects. Truth may be based upon verifiable facts, or by corroborating one or more objects with one or more similar or verifiable accounts. For example, a plurality of accounts may describe the series of events during the construction of a historic house. While the perspectives of each account may vary, some common elements can be corroborated such as the architects and builders involved, the location and time of the construction, the design style of the house, the construction materials used, etc. Verifying common details may provide confidence that the source of the data is trustworthy and therefore their account can be trusted. By contrast, if elements of an individual's account conflicts with the majority of other accounts, then the individual may be deemed less trustworthy, and therefore their story may not be trusted. A first system 102 may additionally aggregate data, such as data about human history and real property development, and upon selection of one or more parameters, may generate a story comprised of one or more relevant accounts of properties, construction events, and/or locations which may then be structured, such as in the chronological order of events, or as locations and/or features as a map, before being presented to a user.

A source database 104 stores data relating to sources of data and the trustworthiness or reliability of the source in relation to real property, properties, land, and housing. A source may refer to an individual providing one or more property narratives, land narratives, or housing data, such as via oral dictation, uploading a recording, providing a written description, a pictorial representation, etc., or may alternatively refer to a property document, written text, publication, publisher, real property website, property management company, land conservation authority, or other organization, etc.

A source may additionally refer to third party networks 128, which may be, for example, real property networks such as the Multiple Listing Service (MLS), Zillow, Realtor.com, etc., third party databases 130, IoT data sources 132, etc. In some embodiments, a source may refer to a user device 134 used to access real property listings or a camera 136 used to capture property images or a sensor 138 deployed within a property or land area. In an embodiment, a source may be a website such as Zillow or Realtor. In another embodiment, a source may be a news company, website, or newspaper publisher such as Bloomberg Real property or The Real Deal. In another embodiment, a source may be a particular building inspector or a certified property or land value. The trustworthiness or reliability may be represented by a binary ‘trustworthy’ or ‘untrustworthy’ data type or may alternatively be represented by a qualitative range of values such as ‘trustworthy’, ‘somewhat trustworthy’, ‘unknown trustworthiness’, ‘somewhat untrustworthy’, or ‘untrustworthy’. Similarly, trustworthiness or reliability may be represented by a quantitative value, such as a score. The score may represent a probability that the source can be trusted, which may be interpreted as the likelihood that the source is accurately describing the property condition or real property market trends. A quantitative value may alternatively utilize a regressive method to adjust the source's reliability score based upon each accurate or inaccurate contribution which may comprise any of a property narrative, real property object, property characteristic, land characteristic, etc. Source reliability may additionally be impacted by credentials, such as whether a source is determined to be a specialist in a real property, property inspection, appraisal, land assessor, or alternatively may be manually adjusted. Additionally, the amount a reliability score is adjusted may be impacted by the degree to which the source's contribution is inaccurate or the relative reliability scores of corroborating sources and data. Sources may further comprise records such as real property records such as property deeds, geographic land coordinates, building permits, contracts, etc.

An event database 106 stores data related to time-related events or data comprising time-based data such as one or more dates, times, and may additionally include descriptions and/or characteristics of what occurred at the specific date and/or time. The resolution of event data in respect to time may vary. For example, an event may reference a time accurate to a second or a fraction of a second, or may reference a specific minute, hour, day, week, month, year, or span of multiple years. For example, an event may describe the purchase of a particular piece of real property, such as a lot, house, warehouse, etc. An event may also comprise construction events, such as building a house, garage, shed, etc. or alternatively landscaping such as adding gardens, trees, fences, etc. Events may further include occurrences at a particular location which may be relevant to the property or land, only due to their occurrence at the property, or due to their occurrence involving one or more individuals or subjects who are relevant to the property. In an embodiment, an event is the construction of a single-family wood frame raised ranch house at 90 Breezy Acres on Jul. 24, 2013. In an additional embodiment, an event is the addition of a two-car garage at 90 Breezy Acres on Aug. 13, 2018. In some embodiments, the event may additionally comprise a duration. For example, the addition of a two-car garage at 90 Breezy Acres may comprise a duration of 36 days. In some embodiments, the event may comprise a start date and/or time, an end date and/or time, or both a start and end date and/or time. In another embodiment, an event is a wedding held at 90 Breezy Acres on Jun. 30, 2021. Event data from one source may be associated with data from a plurality of other sources. Associated data may not match exactly. For example, if a first source was an electrician responsible for electrical work at 90 Breezy acres during the construction of the house in 2013 reported completion of the work on Jul. 7, 2013, while a second source, the general contractor responsible for the construction of the house reported the work was completed on Jul. 24, 2013, the two references would be associated as they are both true and part of the same construction event. The same would be true if they used different resolutions of time-based data, such as if the general contractor reported the work as having occurred in 2013, instead of indicating a specific date or date range, and the electrician reporting Jul. 7, 2013.

A location database 108 stores data related to the location of real estate. The location data may comprise at least an address. Alternatively, or in addition to an address, the location may be comprised of one or more Global Positioning System (GPS) coordinates or similar references to a coordinate system. The coordinates may reference a point representing the entire property, such as the access point to the property or land at a public street. Alternatively, the location may reference one or more features of the property. For example, multiple coordinates may represent the corners defining the shape of a building. Similarly, the coordinates may have a vertical dimension representing altitude and/or height of a building or feature. Locations may further refer to other features, natural, or artificial, to define their location such as a swimming pool, pond, tree, fence, patio, fire pit, grill, etc. Locations may further describe interior features within the home which may include a floorplan, furniture, etc. Associated data may not match exactly. For example, some references may use a common name or address, such as 90 Breezy Acres, while another reference may use a coordinate reference. Similarly, businesses may be described both by the name of the business, the name of an owner, and/or the address of the location. Similarly, businesses may move, while locations may retain the business name. For example, if a “Grand Union” grocery store used to be at 30 Main Street but went out of business and was replaced by a “Walgreens,” then 30 Main Street, “Walgreens”, or “the old Grand Union” may all be equivalent references.

A subject database 110 stores data related to subjects, which may be people, animals, objects, etc. In an ideal embodiment, a subject database 110 stores data primarily related to people. The subject data may relate to specific people, or groups of people. Groups of people may be referenced directly or may comprise an aggregation of data about people belonging to or who can be associated with the group. For example, a group of people may refer to potential buyers of a property. Alternatively, a group may refer to people who lived, worked, or otherwise occupied a property such as residential or commercial properties respectively.

The server system 112 initiates a data collection module 114 and receives data elements collected and identified by the data collection module 114. The server system 112 selects a first data element and initiates a subject module 116, sending the selected data element and receiving subject data comprising data associated with the selected data element. The server system 112 initiates the event module 118, sending the selected data element and receiving event data comprising data associated with the selected data element. The server system 112 initiates the location module 120, sending the selected data element and receiving location data comprising data associated with the selected data element. The server system 112 may then optionally initiate one or more optional modules, sending the selected data element and receiving data related to the optional module comprising data associated with the selected data element. If there are more data elements, another data element is selected and the subject module 116, event module 118, location module 120, and optionally one or more optional modules, may be initiated for each selected data element. If there are no additional data elements, the server system 112 initiates the perspective module 122 and receives data related to a perspective received from a user which has been aggregated. If the aggregated data is to be transferred to another party, initiate the transfer module 124, and receive a transfer status. If the story is not complete, then initiate the perspective module 122 to receive additional perspective parameters to update the story. If the story is complete, then ending the story aggregation.

The data collection module 114 is initiated by the server system 112 and receives data from a data source which may be any of a user via a user device 134, a camera 136, one or more sensors 138, a second system 126, third party network 128, third party database 130, IoT data source 132, etc. The data collection module 114 identifies one or more data elements from the received data and queries a source database 104 for a source reliability score, or for data to facilitate determining a source reliability score. The received data, identified data elements, and source reliability score(s) are then saved to each the event database 106, the location database 108, and the subject database 110 depending on the relevance of the identified data elements to each of the databases. In some embodiments, the identified data elements may additionally be saved to one or more optional databases.

The subject module 116 is initiated by the server system 112 from which it receives a data element and queries a subject database 110. A subject similar to the received data element is selected and the received data element and the selected subject data are compared to determine whether they match. The data element and subject data match if it can be determined that the data describe the same subject, or person. If the data matches, the data are saved to the subject database 110 as matching subjects, that is that they describe the same subject or can be associated with each other, such as may be the case if the data element and the selected subject comprise different levels of specificity, such as describing a person who is a property or land owner versus a specific person who owns a specific property. The subject module 116 checks whether there are more subjects similar to the received subject data. If there are more similar subjects, another subject is selected, and the comparison process is repeated until there are no remaining similar subjects. If there are no similar subjects which match or can be associated with the received data element, the received data element may be saved to a subject database 110 as a new subject. The received data may be saved as a new subject even if it matches or is associated with one or more subjects if the received data element is more specific than the matched or associated subject data. For example, if the matched or associated subject data relates to a general contractor responsible for the construction of a house at 90 Breezy Acres, the received data element may be saved as a new subject if it comprises descriptions of the specific contractor, John Smith. The saved subject data may additionally comprise a source reliability or trust score. The matching and/or associated subject data is then sent to the server system 112.

The event module 118 is initiated by the server system 112 from which it receives event data and queries an event database 106. An event similar to the received event data is selected and the received event data and the selected event data are compared to determine whether they match. The received event data and event data match if it can be determined that the data describes the same event. If the data matches, the data are saved to the event database 106 as matching events, that is that they described the same event or can be associated with each other, such as may be the case if the data element and the selected event comprise different levels of specificity, such as describing the purchase of a residential property versus the purchase of the residential property at 90 Breezy Acres versus the purchase of the residential property at 90 Breezy Acres by James Barker. The event module 118 checks whether there are more events similar to the received event data. If there are more similar events, another event is selected, and the comparison process is repeated until there are no remaining similar events. If there are no similar events which match or can be associated with the received data element, the received data element may be saved to an event database 106 as a new event. The received data element may be saved as a new event even if it matches or is associated with one or more events if the received data element is more specific than the matched or associated event data. For example, if the matched or associated event data relates to the purchase of a residential property, the received event data may be saved as a new event if it further comprises the purchase of 90 Breezy Acres by James Barker. The saved event data may additionally comprise a source reliability or trust score. The matching and/or associated event data is then sent to the server system 112.

The location module 120 is initiated by the server system 112 from which it receives location data and queries a location database 108. A location similar to the received location data is selected and the received location data and the selected location data are compared to determine whether they match. The received location data and selected location data match if it can be determined that the data describe the same location. If the data matches, the data are saved to the location database 108 as matching locations, that is that they described the same location or can be associated with each other, such as describing the same property or real property. The location module 120 checks whether there are more locations similar to the received location data. If there are more similar locations, another location is selected, and the comparison process is repeated until there are no remaining similar locations. If there are no similar locations which match or can be associated with the received location data, the received location data may be saved to a location database 108 as a new location. The received location data may be saved as a new location even if it matches or is associated with one or more locations if the received location data is more specific than the matched or associated location data. For example, if the matched or associated event data describes a neighborhood, such as Breezy Acres, the received data element may be saved as a new location if it comprises a more specific location, such as a specific address, 90 Breezy Acres. The saved location data may additionally comprise a source reliability or trust score. The matching and/or associated location data is then sent to the server system 112.

The perspective module 122 is initiated by the server system 112 and receives one or more perspective parameters describing a desired story to be generated. Each of the event database 106, location database 108, and subject database 110 are queried, in addition to any relevant optional databases and data relevant to the received perspective parameters are selected. Each of the selected data records are arranged chronologically and based upon physical locations. In an embodiment, the aggregated story comprises the experiences of the owner of 90 Breezy Acres, James Barker at or related to 90 Breezy Acres. In another embodiment, the aggregate story comprises a history of taxes and fees due/or paid related to 90 Breezy Acres. In some embodiments, the perspective module 122 may aggregate data related to the property or land use, e.g., commercial, residential, industrial, investment property, rental, vacation or second home, etc. The aggregated data, which may comprise further ordering, is returned to the server system 112.

A transfer module 124 operates similar to a subject module 116, event module 118, or geography location module 120 by receiving a data element, querying a relevant database, and comparing the data retrieved from the database to the received data element to identify matching or associated data.

Second system 126 can be a distributed network of computational and data storage resources which may be available via the internet or by a local network. Second system 126 accessible via the internet is can be referred to as a public cloud whereas second system 126 on a local network can be referred to as a private cloud. Second system 126 may further be protected by encrypting data and requiring user authentication prior to accessing its resources.

A third party network 128 is comprised of one or more network resources owned by another party. For example, a third party network 128 may refer to a service provider, such as those providing Real property listings such as Zillow or Realtor. Alternatively, a third party network 128 may refer to a news website or publication, a weather station, bank, mortgage services, insurance company, municipality, etc.

A third party database 130 stores data owned by another party. For example, a third party database 130 may store data on a third party network 128, or may alternative comprise archival data, historical accounts, survey results, customer feedback, social media posts, etc. In one embodiment, a third party database 130 may include for example, a municipal database of property taxes due and/or paid.

An IoT (Internet of Things) IoT data source 132 is an internet connected device which may comprise one or more sensors or other sources of data. IoT data sources 132 may comprise appliances, machines, and other devices, often operating independently, which may access data via the internet, second system 126, or which may provide data to one or more internet connected devices or second system 126.

A user device 134 is a computing device which may comprise any of a mobile phone, tablet, personal computer, smart glasses, audio, or video recorder, etc. In some embodiments, a user device 134 may include or be comprised of a virtual assistant. In other embodiments, a user device 134 may comprise one or more cameras 136 and/or sensors 138. A user device 134 may comprise a user interface for receiving data inputs from a user.

A camera 136 is an imaging device or sensor 138 which collects an array of light measurements which can be used to create an image. One or more measurements within the array of measurements can represent a pixel. In some embodiments, multiple measurements are averaged together to determine the value(s) to represent one pixel. In other embodiments, one measurement may be used to populate multiple pixels. The number of pixels depends on the resolution of the sensor 138, comprising the dimensions of the array of measurements, or the resolution of the resulting image. The resolution of the camera 136 sensor 138 does not need to be the same as the resolution of the resulting image. A camera 136 may be a component in a user device 134 such as a mobile phone, or alternatively may be a standalone device. In some embodiments, a camera 136 may be analog, where an image is imprinted on a film or other medium instead of measured as an array of light values. A sensor 138 is a measurement device for quantifying at least one physical characteristic such as temperature, acceleration, orientation, sound level, light intensity, force, capacitance, etc. A sensor 138 may be integrated into a user device 134, such as an accelerometer in a mobile phone, or may be a standalone device. A sensor 138 may also be found in an IoT data source 132 or a third party network 128.

A value module 140 may be a component of the first system 102, in some examples. Value module 140 offers a robust system for determining, computing, and tracking diverse types of value tied to a real estate. Beyond fiat currency monetary value based on standard real property factors, the module extends its functionality to compute alternate value systems including historical, cultural, sentimental, metaphysical, strategic, ecological, aesthetic, social, scientific, educational, and health values. The module utilizes data from the SIO, correlating it with these value systems to offer a comprehensive, dynamic valuation of the property. Additionally, the value module 140 also calculates a Collectability Index, effectively evaluating a property's appeal to collectors based on its uniqueness, historical importance, architectural style, and other variables, offering real-time updates to stakeholders on potential fluctuations in the collectability of their property.

Value module 140 serves a role in the determination, calculation, and longitudinal tracking of various types of value associated with a piece of real property or property. The value module 140 has the capability to analyze and quantify monetary value, commonly regarded as the property's market price, based on factors such as location, size, age, condition, and numerous other variables. However, this module transcends traditional property valuation paradigms, incorporating a plurality of alternative value systems. These value systems can span across a broad spectrum, reflecting the multidimensional nature of value perception in real property. These value systems may include, but are not limited to, historical value, a metric that quantifies the worth based on the property's historical significance or antiquity; cultural value, tracking the value derived from the property's cultural significance or contribution to the local or global culture; sentimental value, encapsulating the emotional attachment or personal history tied to the property; and metaphysical value, capturing the perceived spiritual or mystical worth associated with the property. The value module 140 can also consider strategic value, which assesses the property's importance in relation to commercial or military operations, such as proximity to key infrastructures or geographic advantages. Furthermore, it can account for ecological value, quantifying the worth based on the property's contribution to local ecology or biodiversity; aesthetic value, focusing on the architectural or scenic appeal of the property; and social value, evaluating the property's role in facilitating community bonds or social interactions. Additionally, the value module 140 may be programmed to compute for scientific value, appraising the property's relevance to scientific research or studies; educational value, signifying the property's potential as an educational resource; and health value, reflecting the property's contribution to public health, such as access to clean air, sunlight, or recreational spaces. This module operates by correlating the data from the SIO to the respective value systems, thus, creating a holistic representation of the property's value. As the SIO accumulates more data over time, the value module 140 is designed to continuously update and refine its valuation, ensuring an accurate and dynamic reflection of the property's value in real-time. This allows stakeholders to make informed decisions based on a comprehensive understanding of the property's intrinsic and extrinsic worth, beyond mere monetary terms. In addition to the various value systems described previously, the value module 140 is also equipped to evaluate the collectability of a piece of real property. The concept of collectability in real property refers to the potential of a property to be sought after by collectors, much like art or vintage automobiles. This can be influenced by a variety of factors including uniqueness, historical significance, architectural design, cultural impact, location, or the prestige associated with previous owners. The value module 140 determines the collectability of a property by synthesizing a multitude of data sources available in the SIO. This includes, but is not limited to, historical data such as past ownership records, architectural blueprints, and preservation status, as well as more dynamic data such as market trends, cultural shifts, and public sentiment. For example, a property may be deemed collectible if it was designed by a renowned architect, or if it was the former residence of a notable individual. Similarly, properties located in areas that have gained cultural or historical prominence, or unique properties that embody specific architectural styles or periods could also be seen as collectible. The value module 140 analyzes all these factors and more to compute a Collectability Index for the property. This index is a numerical representation of the property's appeal to collectors, and can vary over time as market trends, cultural values, and historical contexts evolve. As part of its function, the value module 140 continues to track changes in this index, providing real-time updates and trend analyses to inform stakeholders about potential fluctuations in the collectability of their property. This allows property owners, investors, and collectors to make informed decisions about acquisitions, dispositions, and potential value appreciation of collectible real property.

The brand module 142 is a component of the first system 102 in the context of the SIO system for real property properties, where it manages the brand-related aspects of these properties. It's designed to handle brand ownership and its related nuances, touching upon stakeholders such as investors, developers, builders, architects, and real property agents. This module supplies unique brand-related data into the SIO, which can include information about architectural styles that a particular builder or architect is known for, the typical locations of a developer's properties, and the types of clientele or industries the brand caters to. In addition to that, the brand module 142 manages the reputation data of the associated brands, accounting for customer reviews, awards, and recognitions. It stores marketing materials like promotional content, advertisements, and property photographs, which can be used as a reference by potential buyers, renters, or investors. Press releases, published articles, and other forms of media coverage about the brand are tracked by this module, providing further insight into the brand's public perception. Visual identity aspects such as logos and insignia that signify the brand's identity are also taken into account by the brand module 142. Moreover, it pays attention to other unique tangible or intangible attributes related to a brand such as construction quality, eco-friendliness, community involvement, or historical or cultural relevance of the properties. By handling this vast array of brand-related data, the brand module 142 significantly contributes to creating a social identity for real property properties or land within the SIO system.

The brand module 142, operatively connected to the first system 102, enables the capture and processing of brand-related data to be integrated into the SIOs of real property properties. In one embodiment, the brand module 142 handles brand-related data of a developer who specializes in constructing high-end, luxury apartment complexes aimed at young professionals. Such brand-related data could encompass unique architectural features, specific amenities, the upscale nature of the neighborhoods chosen for these developments, customer testimonials, and any reputation-enhancing awards or recognition the brand has received. This data is used to formulate an SIO that accurately represents the brand's unique identity and value proposition in the real property market. In another embodiment, the brand module 142 manages the brand data of an investment firm that specializes in creating modern office spaces for rapidly growing startup companies. The brand module 142 may gather and process data about the design philosophy, sustainability practices, spatial planning strategies, incorporation of innovative technologies, and client satisfaction levels. This brand-related data is then integrated into the SIO of the office spaces developed by the investment firm, contributing to a holistic understanding of the brand's identity and its impact on the physical objects, i.e., the properties. In a further embodiment, the brand module 142 is able to manage brand-related data of an architectural firm that excels in creating custom homes inspired by mid-century modern designs reminiscent of Frank Lloyd Wright's architecture. While the firm's designs often reference Frank Lloyd Wright's work, they maintain their uniqueness through various distinct elements, such as an emphasis on elegant integration with the surrounding environment. The brand module 142 is equipped to distinguish the unique elements of this firm's designs from actual Frank Lloyd Wright designs, effectively creating separate SIOs for each brand. The brand module 142 is capable of discerning such distinguishing attributes, connections, similarities, and divergences among a plurality of brands. Some brands may have a distinct brand manager authorized to contribute and verify brand information, while others may adopt a franchise model with multiple brand managers having authorization to contribute data. Yet other brands may adopt an open-source approach, allowing any contributor to associate their property with the brand if it satisfies certain criteria. For instance, a creator of an open-source blueprint for an environmentally friendly “Tiny Home” may permit any individual to download the plans, build the home as per the specifications, and contribute SIO data related to the Tiny Home without any formal verification or authorization. In this scenario, the brand module 142 has capabilities to cross-verify the uploaded SIO data with the defined attributes of the “Tiny Home” brand, ensuring consistency and credibility. The brand module 142 thus provides a versatile, comprehensive, and efficient means to manage and authenticate brand-related data for real property properties within the SIO system.

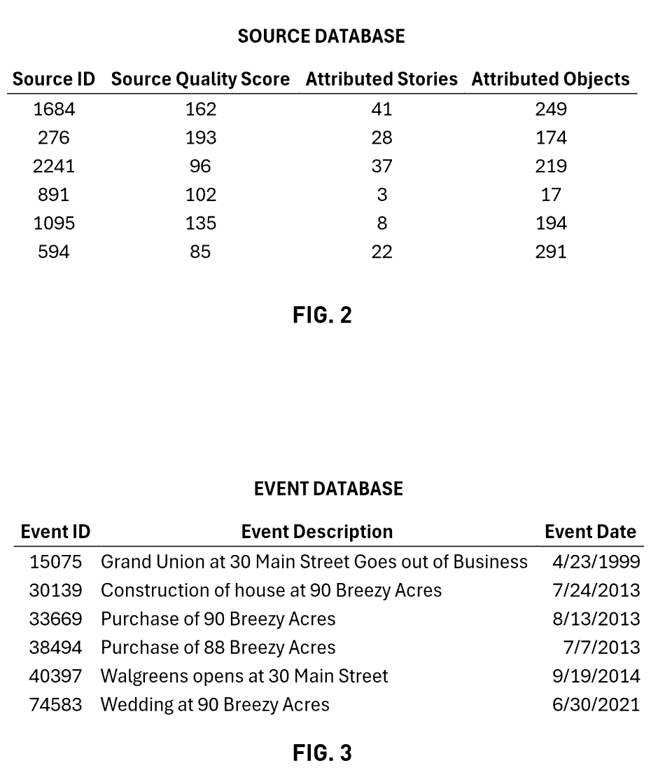

FIG. 2 illustrates an exemplary source database 104. The source database 104 stores data relating to sources of data, and particularly an indication of the trustworthiness or reliability of the source in relation to housing and real property information. The reliability of the source may be determined based upon analysis of one or more property stories or housing data which may be attributed to the source and/or one or more objects which may be attributed to the source. A property story is a data record which may be comprised of one or more objects, which are individual data elements related to real property. The source database 104 may be populated by a trust verification system. The source database 104 may be used by the server system 112, data collection module 114, subject module 116, event module 118, location module 120, and may be further utilized by one or more optional modules. These modules work together to gather, analyze, and verify real property information for the SIO in the realm of real property and housing. In one embodiment, the source database 104 may include information provided by a prior owner of a specific property. This source, who can be designated as a trusted individual due to personal experience with the property, can provide a detailed history of the house both in terms of physical characteristics and sentimental experiences. This data may comprise descriptions of the property's physical aspects such as the external paint color, information about any previous damage and repairs, and details about the home's architectural elements. Beyond these tangible details, the source may also include metaphysical reflections and emotive recollections tied to the property or land. These may encompass personal anecdotes such as the joy derived from raising children in the expansive family room, the sense of togetherness fostered by cooking meals as a family in the open layout of the kitchen, or the serene contemplation experienced while admiring the beauty of the property's well-maintained garden. These emotive aspects help to build a social identity of the property object, providing potential buyers with a deeper understanding and connection to the property or land beyond its physical attributes. In another embodiment, the source database 104 may include information from an external organization, such as a census bureau, that has compiled demographic and societal information about the property's neighborhood over a certain period. This source, established as reliable due to its methodical data collection and analysis, can provide an overview of the land or property's societal context. For example, the data may reveal that the house once accommodated three generations of a single family, offering potential buyers insights into its capacity for multi-generational living. The source data can further elaborate on the demographics of the neighborhood, such as the fact that the area houses many children between the ages of 3-17, providing a potential indicator of a family-friendly environment. Employment statistics, such as 80% of the street's residents being gainfully employed, can also be included, providing insights into the economic stability of the neighborhood. This type of demographic and societal data serves to enhance the social identity of the land or property object by providing potential buyers with a clear picture of the land or property's community context.

FIG. 3 illustrates an exemplary event database 106. The event database 106 stores data related to time-based events such as those which comprise a time data reference. The event data may comprise at least one date and descriptions of one or more events which occurred on that date. The date may additionally comprise a time. The date may instead comprise a year, or a range of years, or alternatively a date range between two specific dates, weeks, months, times, etc. The event database 106 is populated by a data collection module 114 and is updated by an event module 118. The event database 106 may additionally be populated by one or more of second system 126, third party network 128, third party database 130, IoT data source 132, user device 134, camera 136, or one or more sensors 138. The event database 106 is utilized by the event module 118 and the perspective module 122. In one embodiment, the event database 106 may contain data related to specific time-based events associated with a land area or property, provided by a historical society. The historical society, an organization known for its reliability in chronicling and preserving local history, could detail key events that took place in the land area property or its vicinity, thus contributing to the property's social identity. For instance, the data could reveal that the property was constructed in the year 1920, indicating its historical significance. Other notable events may include the date the property underwent a significant renovation in the 1980s, introducing a modern twist to its classic architecture. Another entry might mark the time the property was featured in a popular local garden tour due to its exceptional landscaping in the year 2000. By associating these events with specific dates or date ranges, the event database 106 provides a chronological narrative that gives depth and context to the property's story. In another embodiment, the event database 106 might contain data gathered from a local environmental monitoring agency. This reliable source could provide time-stamped data on local environmental changes and events that impact the neighborhood where the property is located. For instance, the environmental monitoring agency's data might reveal that in the past decade, the neighborhood has experienced an increase in green space due to a local initiative, positively impacting air quality and natural beauty. Another entry might indicate a flood event that occurred twenty years ago, but due to successful municipal infrastructure improvements, the risk has been mitigated. This time-based environmental information offers potential buyers a comprehensive understanding of the property's environmental context over time, contributing to its social identity.

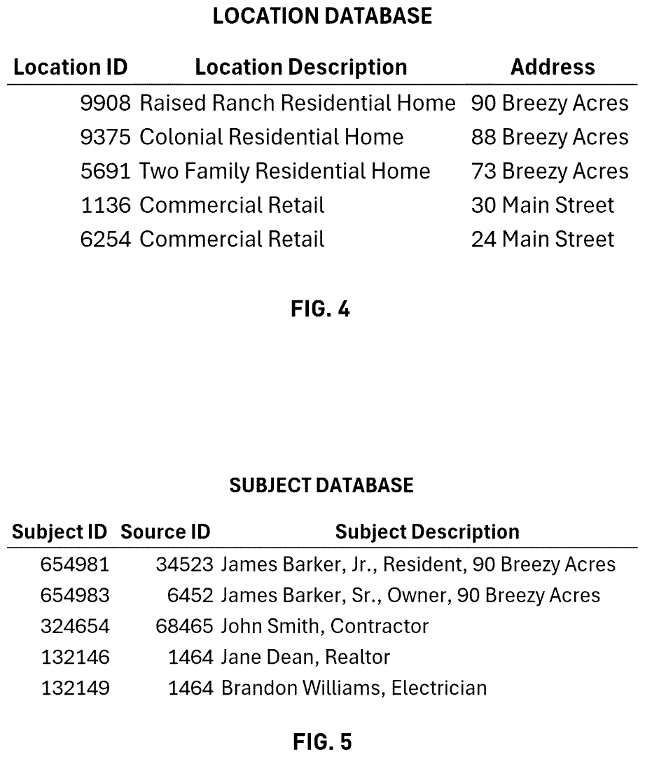

FIG. 4 illustrates an exemplary location database 108. The location database 108 stores data related to location-based data such as those which describe locations. The location data may comprise any of a continent, country, state, city, town, street, address, building, etc. Location related data may also comprise GPS coordinates, regions, including common names, as well as geographic features, such as mountains, valleys, canyons, rivers, streams, lakes, oceans, etc. In an ideal embodiment, the location database 108 stores location references for property or real property. The location database 108 is populated by a data collection module 114 and is updated by a location module 120. The location database 108 may additionally be populated by one or more of second system 126, third party network 128, third party database 130, IoT data source 132, user device 134, camera 136, or one or more sensors 138. The location database 108 is utilized by the event module 118 and the perspective module 122. In one embodiment, the location database 108 may contain data provided by a city's zoning and planning department. This trustworthy source can offer a range of location-specific information about a particular property, contributing to its SIO. For example, the data could include that the property is located in a designated historic district, providing added context for its architectural and cultural significance. It might also indicate that the property is in a residential zone that prohibits commercial use, providing potential buyers with valuable information on possible uses. Furthermore, this source may provide geographical data, such as the property being situated on a hill, offering scenic city views, or its proximity to essential public facilities like parks, schools, and hospitals. The GPS coordinates could also be stored to facilitate accurate location pinpointing. In another embodiment, the location database 108 could include data obtained from a local community organization, providing information about the neighborhood where the property is situated. This information can give potential buyers an idea of the community they'd be joining. The community organization's data might include the fact that the property is part of a neighborhood with a strong community association and yearly block parties, fostering a sense of community spirit. It might also mention the neighborhood's reputation for being family-friendly with a low crime rate, or its location within walking distance to local shops, restaurants, and public transport facilities. This location-based data significantly contributes to the property's social identity by offering a broader societal context.

FIG. 5 illustrates an exemplary subject database 110. The subject database 110 stores data related to people, animals, objects, etc., although in ideal embodiments the subject database 110 primarily describes documents individuals and their related characteristics, especially as they pertain to real property or housing. The subject data may comprise descriptions of a person, groups and affiliations, and roles they may have fulfilled. The subject data may include a detailed description of an individual's relationship to a property. This can range from homeowners, such as John Smith who owned and resided in the house for thirty years, to real property professionals, such as Jane Doe, the architect who designed the property. Data might include descriptions of individuals' roles, like the contractor who built the extension, the interior designer who styled the living space, or the realtor who has managed multiple sales of the property, etc. In an ideal embodiment, the subject database 110 may store data related to a subject's relationship to a property or real property or alternatively a role which is relevant to real property such as a contractor, realtor, electrician, etc. Subject data may be specific, such that it describes specific individuals, or may be more generalized, such that it describes a group of people. An individual may be a specific property owner, James Barker, and a group may refer to the Barker family, or the construction company responsible for the building's structural work. It might also document homeowners' associations, neighborhood committees, or tenant unions related to a particular property or housing complex. The subject database 110 is populated by a data collection module 114 and is updated by a subject module 116. The subject database 110 may additionally be populated by one or more of second system 126, third party network 128, third party database 130, IoT data source 132, user device 134, camera 136, or one or more sensors 138. The subject database 110 is utilized by the event module 118 and the perspective module 122. In a first embodiment, the subject database 110 may contain data pertaining to a specific individual, Robert Green, a previous homeowner of a certain property located at 123 Maple Street. The database may contain comprehensive records about Robert Green, his personal details, occupation, family composition, and his tenure of ownership. It may contain additional information about his role in the property's history, such as undertaking significant renovations in 2025, including the addition of a solar energy system and a backyard pool. This would add to the overall social identity of the property, not only depicting its physical changes over time but also capturing the narrative of a responsible and eco-friendly homeowner. In a second embodiment, the subject database 110 may store data about the renowned real property firm, Prestige Properties, that has had a significant impact on the housing landscape in the city. It might record that Prestige Properties has been instrumental in developing several prominent housing complexes and has won several awards for their innovative architectural designs. It may also document specific employees who have been key in these achievements. For instance, it might note that Sarah Thompson, a top realtor at Prestige Properties, has facilitated several high-profile property transactions in the city. Furthermore, it might track the firm's role in managing 123 Maple Street, providing information about when and how they came to represent the property, and their role in its transactions, renovations, or maintenance over the years. This data would contribute to a broader understanding of the property's historical context and its place within the larger real property landscape.

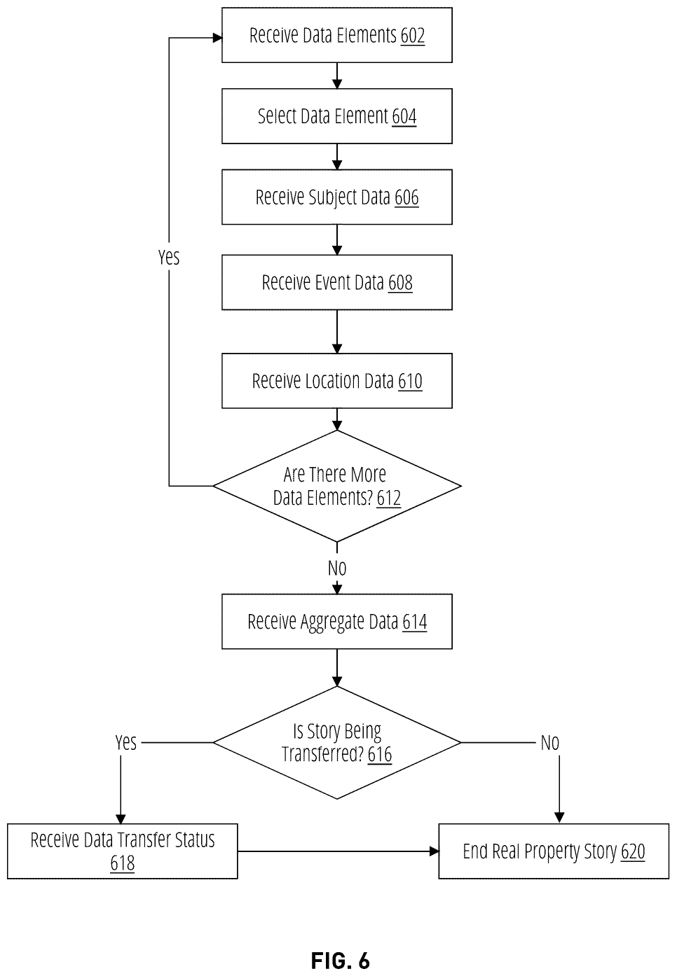

FIG. 6 is a flowchart illustrating an exemplary function of the server system 112. The process begins with initiating the data collection module 114. The data collection module 114 receives data from at least one data source and identifies data elements comprising the received data such as discrete events, locations, people, items, etc. The data collection module 114 queries the source database 104, determines a source reliability score, saves event data to the event database 106, location data to the geography database 108, and subject data to the subject database 110. The saved event data, location data, and subject data may additionally be accompanied by a source reliability score.

Server system 112 receives the identified data elements from the data collection module 114 at operation 602. For example, a data element may be a subject, James Barker, the owner of the property at 90 Breezy Acres. In another embodiment, the data element may comprise location data such as 90 Breezy Acres or the former Grand Union. The data elements may further comprise events, such as the sale of a property, construction and/or maintenance events, visitors, etc.

Server system 112 selects, at operation 604, a data element from the at least one data element received from the data collection module 114. In an embodiment, selecting the purchase of the property at 90 Breezy Acres by James Barker. In an alternate embodiment, selecting the construction of a house at 90 Breezy Acres by a contractor.

Server system 112 initiates the subject module 116, which receives data comprising at least one subject and querying the subject database 110, selects a subject similar to the received subject data, and determines whether the selected subject data matches the received subject data. If the data matches, server system 112 saves the received data as matching the selected subject to the subject database 110. If the subject data does not match, server system 112 checks whether there are more similar subjects. If there are more similar subjects, server system 112 selects another subject and determines whether the selected subject data matches the received subject data. If the received subject data does not match any data from the subject database 110, then server system 112 saves the received subject data as a new subject to the subject database 110.

Server system 112 receives, at operation 606, the subject data from the subject module 116. The subject data comprises matched subjects and/or newly identified subjects. Subjects may comprise people or things. Matching subjects are associated so as to add new details to an existing subject and/or corroborate existing details. Subject data may additionally be accompanied by a source score which indicates the reliability of the source. The reliability of the source may be retrieved from the source database 104 and/or may utilize a story corroboration system or other method of determining the reliability of the received data.

Server system 112 initiates the event module 118, which receives data comprises at least one event and querying the event database 106, selects an event similar to the received event data, and determines whether the selected event data matches the received event data. If the data matches, server system 112 saves the received data as matching the selected event data to the event database 106. If the event data does not match, server system 112 checks whether there are more similar events. If there are more similar events, then server system 112 selects another event and determines whether the selected event data matches the received event data. If the received event data does not match any data from the event database 106, then server system 112 saves the received event data as a new event to the event database 106.

Server system 112 receives, at operation 608, the event data from the event module 118. The event data comprises matched events and/or newly identified events. Events may comprise discrete or notable actions, or other time-based data. In some embodiments, an event may refer to something which occurred or the state of people, things, etc. at a specific date and/or time. The resolution of time may be one or more years, months, weeks, days, hours, minutes, seconds, etc. Matching events are associated so as to add new details to an existing event and/or corroborate existing details. Event data may additionally be accompanied by a source score which indicates the reliability of the source. The reliability of the source may be retrieved from the source database 104 and/or may utilize a story corroboration system or other method of determining the reliability of the received data.

Server system 112 initiates the location module 120, which receives data comprising at least one location and querying the location database 108, selects a location or location characteristic similar to the received location data, and determines whether the selected location data matches the received location data. If the data matches, server system 112 saves the received data as matching the selected location data to the location database 108. If the location data does not match, server system 112 checks whether there are more similar locations. If there are more similar locations, then server system 112 selects another location and determines whether the selected location data matches the received location data. If the received location data does not match any data from the location database 108, then server system 112 saves the received location data as a new location to the location database 108.

Server system 112 receives, at operation 610, the location data from the location module 120. The location data comprises matched locations and/or newly identified locations. Locations may describe countries, regions, cities, towns, villages, streets, buildings, etc. or may alternatively comprise a set of coordinates such as GPS or map coordinates. The resolution of location may comprise a distance or area of any scale ranging from inches or feet, millimeters, or meters, to hundreds or thousands of miles or kilometers. In some embodiments, locations may be described by natural geographic features such as lakes, rivers, streams, mountains, valleys, canyons, etc. Matching locations are associated so as to add new details to an existing location and/or corroborate existing details. Location data may additionally be accompanied by a source score which indicates the reliability of the source. The reliability of the source may be retrieved from the source database 104 and/or may utilize a story corroboration system or other method of determining the reliability of the received data.

Server system 112 checks, at operation 612, whether there are more data elements. If there are more data elements, then server system 112 returns to operation 604 and selects another data element. In some examples, there is another data element comprising the listing of the property at 90 Breezy Acres by a realtor, therefore server system 112 returns to operation 604, and selects the data element comprising the listing of the property at 90 Breezy Acres. In an alternate embodiment, there are no more data elements.

Server system 112 initiates the perspective module 122, which receives a perspective from the user. The perspective may comprise any one or more of a subject, event, location, etc. For example, a perspective may comprise the owner of the property at 90 Breezy Acres. The perspective module 122 queries the event database 106, the location database 108, and the subject database 110 for data relating to the provided perspective. The related data is then used to create a timeline of events, a map of events, and may additionally summarize a plurality of perspectives such as from multiple subjects and data sources. In some embodiments, additional modules may be utilized to identify, match, and retrieve more specific types of data.

Server system 112 receives, at operation 614, the aggregate data from the perspective module 122. The aggregate data is assembled to form a story such as via a chronological account of events. The aggregate data may comprise a plurality of accounts, which may be summarized from a plurality of subject, event, or location data. In some embodiments, the aggregate data may comprise generalizations or inferences from the available data. In other embodiments, the aggregate data may be more specific, such as the construction and maintenance history for 90 Breezy Acres according to work orders, permits, invoices, etc.

Server system 112 determines, at operation 616, whether the story is being transferred. The story may be transferred if an event occurs which requires the transfer of information, such as the sale of property or real property. Alternatively, a story may be transferred, or shared, with visitors or guests, or for another purpose, such as to facilitate the renovation of a building by a contractor. In such examples, the story, if applicable, may be transferred in part, or full, and similarly, access to the story may be removed or maintained for the original owner of the information.

Server system 112 initiates the transfer module 124, which sends the aggregate data and/or story to the transfer module 124 and identifying at least one transferee perspective. If the transferee perspective and the aggregate data and/or story perspectives are relevant, identify a transfer condition and/or event upon which the data should be transferred. The data is transferred when the transfer condition has been satisfied and may comprise sharing of data, or a complete or partial transfer of relevant data. In some embodiments, the aggregate data and/or story may be altered to be relevant to the transferee's perspective which may include removing personal information related to the original owner.

Server system 112 receives, at operation 618, a data transfer status from the transfer module 124. The data transfer status may indicate that the transfer of data has occurred. In other embodiments, the data transfer status may indicate an error or other condition where the data transfer did not occur. Server system 112 ends, at operation 620, the story aggregation and transfer if the story is complete.

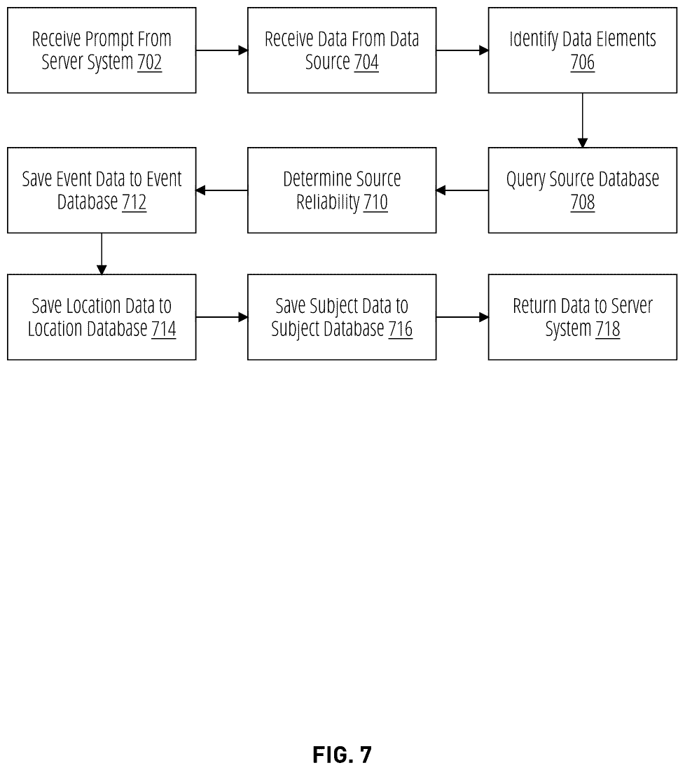

FIG. 7 is a flowchart illustrating an exemplary function of the data collection module 114. The process begins with receiving, at operation 702, a prompt from the server system 112 to begin collecting data from at least one user and/or data source.

Operation 704 includes receiving data from at least one data source. In an embodiment, the data source may comprise a user using a user device 134. The user may manually input data via a physical or virtual keyboard interface or may alternatively dictate the input data verbally or upload one or more images taken by one or more cameras 136. In one embodiment, the data source might include a resident of a property, who shares memories of the house through a user device 134. The resident might relay stories about a famous local artist who once stayed at the property or the joy of homeschooling children in a specially designed room. The data source may alternatively comprise any of second system 126, third party network 128, third party database 130, IoT data source 132, camera 136, sensors 138, or a user device 134. For example, the data source might be a third-party third party network 128, such as a social media platform where a well-known activist group has discussed a key meeting that took place at the property. In other cases, local news archives in a third-party third party database 130 might provide data about an underground punk band that held a legendary house show at the location. The data collection may be passive, such as passively recording from a camera 136 or one or more sensors 138 which may include a microphone. For example, sensor 138 may be used for capturing the ambient noise levels and light conditions that make a property particularly peaceful and appealing. Data can be also received from IoT data source 132, such as smart home devices that record the property's temperature preferences and energy usage, providing insights into the sustainable living practices of the residents. The data collection may also comprise receiving data from remote sources, such as second system 126, third party network 128, third party database 130, or an IoT data source 132. Likewise, a camera 136 may be one or more security cameras observing one or more individuals, locations, events, etc. In some embodiments, the received data may comprise construction and/or repair records and/or invoices, real property listings, sales, etc. The received data may also comprise data related to events occurring at a specific location defined as a property or may further relate to a specific location within a real estate.

Operation 706 includes identifying at least one data element from the received data. A data element may comprise a data characteristic, such as a person, animal, object, location, time, event, etc. Data elements may be identified differently depending upon the format of the data. For example, if the data is provided as text, a transcription, or an audio dialogue, the language may be analyzed, primarily segregating by nouns and verbs, and further evaluating whether each noun or verb references a discrete element. Nouns may indicate a person, animal, object, location, time, events, etc. whereas verbs may additionally refer to events. Alternatively, the data may be subjected to an algorithm or utilize machine learning and/or artificial intelligence to use methods such as a convolutional neural network to segregate the content into discrete elements while additionally accounting for context. Image and video may utilize image recognition to identify objects and object characteristics. In some embodiments, objects may be manually defined or refined. A data element may be a subject, such as the resident of a single-family home. A data element may be an event, such as a wedding occurring at a specific location, purchase or sale of a property, modifications and/or maintenance of a property, etc. In an ideal embodiment, a data element may comprise location data such as an address, common name, GPS coordinates, etc. The data elements may additionally include names of other visitors to a residence or alternatively customers and/or employees at a commercial location. These elements may be a subjective account of the property's atmosphere during a holiday celebration, the emotional value of a family raising multiple generations in the house, or the intangible legacy left by the influential people who have frequented the property. Data may also pertain to the sentimental value of a particular room in the house used for homeschooling.

Operation 708 includes querying the source database 104 for a score indicating the reliability of the data source from which the data was received. The data score may be binary, indicating whether the data source is trustworthy or not. Alternatively, the data score may be a fixed scale, with several degrees of trust or reliability between a minimum and maximum value. In other embodiments, the data score may be numerical with no fixed scale. Likewise, the scale may comprise only positive values, or may additionally allow negative values. In an ideal embodiment, the source reliability score is numerical and not on a fixed scale, and the larger the number, the more reliable the source.

Operation 710 includes determining the reliability of the source by retrieving a source score from the source database 104. In an embodiment, the reliability score for a personal narrative shared by the homeowner might be 432, whereas the reliability score for data extracted from a verified news article about an important event at the property could be higher. In an alternate embodiment, the source does not have a source score and therefore is assigned a default value of 100. In other embodiments, a story verification system is used to verify and corroborate the accuracy of the contributed story to determine the source reliability score. In an embodiment, a personal account of a wedding by an attendee may be less trustworthy than a camera recording of the event. Likewise, a homeowner's account of a plumbing issue may be less trustworthy than an invoice from a plumber for work done to repair a bathroom drain.

Operation 712 includes saving identified event data to the event database 106. An example of event data may be the construction of a single-family wood frame raised range house at 90 Breezy Acres which concluded on Jul. 24, 2013. In another embodiment, an event may comprise a wedding which occurred at 90 Breezy Acres on Jun. 30, 2021. The event data may additionally comprise a source reliability score. In one embodiment, Emotional or metaphysical events related to the property, such as the memorable house show played by the punk band, are saved to the event database 106.

Operation 714 includes saving location data to the location database 108. An example of location data may be an address, such as 90 Breezy Acres. In another embodiment, location data may comprise a common name, such as the local “Walgreens” or the “Old Grand Union”. The location data may additionally comprise a source reliability score. In one embodiment, details about the property's unique features that facilitate homeschooling are stored in the location database 1088.

Operation 716 includes saving identified subject data to the subject database 110. An example of subject data may be the owner of a property at 90 Breezy Acres. In another embodiment, a subject may be an attendee at a wedding. In another embodiment, the subject data may comprise a realtor involved in the sale of the property at 90 Breezy Acres. In another embodiment, a subject may be a construction worker or technician involved in the building and/or maintenance of a property. The subject data may additionally comprise a source reliability score. In one embodiment, subject data, such as the profiles of the family members who lived in the house or information about the artist who once stayed there, are saved to the subject database 110.

Operation 718 includes returning the data, and source reliability score(s) to the server system 112, aiding the construction of a nuanced and rich Social Identity of the property, encapsulating not just its physical characteristics and factual history, but also its intangible and emotional significance to various individuals and groups.

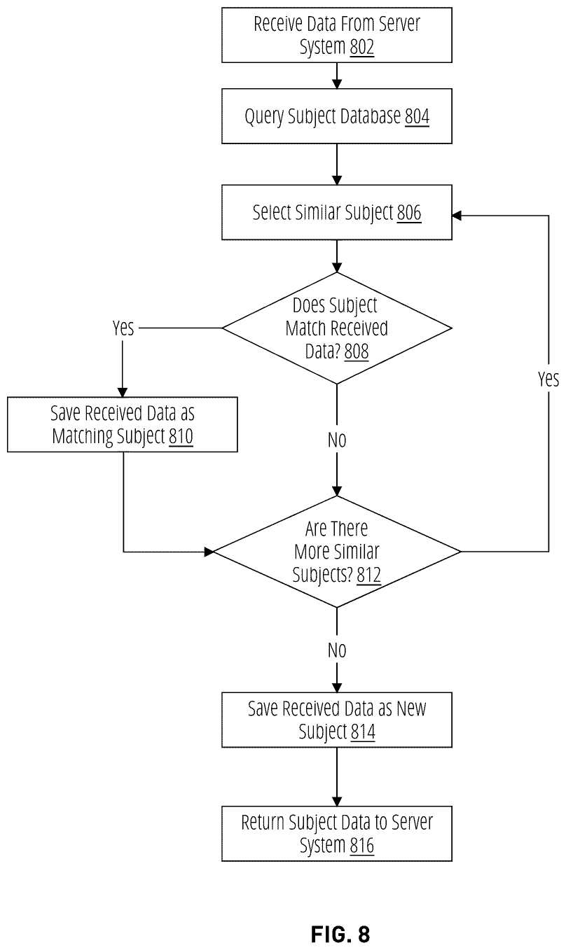

FIG. 8 is a flowchart illustrating an exemplary function of subject module 116. The process begins with receiving, at operation 802, data from the server system 112. The data comprises an identified data element which may include data elements representing subjects such as people, animals, objects, etc. The subject may be specific, such as a specific person, or may be more general, such as referring to all or any person matching a description, such as a property owner, realtor, buyer, seller, resident, visitor, electrician, plumber, etc. For instance, a builder, during the construction process, could offer data about the materials used, the construction techniques employed, and the energy efficiency measures integrated. This data is identified and received as a unique data element.

Operation 804 includes querying the subject database 110 for subject data which is similar to the received subject data. For example, if the received subject data comprises a description of a property owner of a single-family wood frame raised ranch home, then querying the subject database 110 for data related to property owners of single-family wood frame raised ranch homes. If the received subject data related to a dog, then query the subject database 110 for data related to dogs. In one example, the subject database 110 would be queried for data related to the construction of properties with similar characteristics.

Operation 806 includes selecting a subject from the subject database 110 similar to the received subject data. In an embodiment, the received subject data comprising the description of a property owner of a single-family wood frame raised ranch home, therefore selecting a subject from the subject database 110 describing a property owner of a single-family wood frame raised ranch home. Alternatively, This could involve selecting data from another builder who had constructed a similar property.

Operation 808 includes determining whether the selected subject from the subject database 110 matches the description in the received subject data sufficient to confirm that both descriptions describe the same subject. For example, matching a specific property owner may require that the name, date of birth, date of ownership, and other identifiable information is the same sufficient to positively identify and confirm a match. If the subjects do not match, then check if there are more similar subjects. In an embodiment, the received data describes a property owner named James Barker born in 1964, whereas the selected subject data describes a property owner named Joseph Barker born in 1935, therefore the subjects are different despite having the same name. Further, a first property owner named James Barker may be born in 1964, whereas a second property owner, also named Joseph Barker, is born in 1926. As the dates of birth are different, they are not the same person, even if they reside at the same residence. Similarly, a distinction may be made between Joseph Barker Jr. and Joseph Barker Sr. In some instances, these may refer to different people, such as if Jr. refers to the son of Joseph Barker Sr. In other instances, such as where there are three generations of property owners named Joseph Barker, the second generation may both be referred to as Joseph Barker Jr. and Joseph Barker Sr. depending on the context. The additional context may comprise time data, references to ages, height, etc. In an alternate embodiment, the selected subject data matches the received data element. The data does not need to be an exact match but should not comprise any unresolved conflicts. For example, if the height is off by an inch, but all other descriptions match, there may be a discrepancy with the height approximation, but it may still be concluded that both descriptions reference the same individual. On the other hand, if the descriptions have a key detail which cannot be resolved, such as the name on a document, then the discrepancy cannot be resolved, unless the description included a statement that the individual legally changed their name or otherwise assumed an alias matching the subject. It should also be noted that a data match may either be exact or may be generalized or more relative. For example, in some embodiments the received subject data may be evaluated for an exact match to a specific person, whereas in other embodiments, it may be more general, such as matching the description of a property owner, contractor, realtor, etc. In such embodiments, details such as a name may only be relevant if it is compared against a database comprising property ownership documents or property taxes, licensing such as for contractors and/or realtors, etc. In some embodiments, the source reliability score could be based on factors such as the builder's years of experience, portfolio of completed projects, and reputation in the industry.

Operation 810 includes saving the received data as matching the selected data to the subject database 110. A source reliability score may additionally be determined and saved to the subject database 110 with the matched data.

Operation 812 includes checking whether there are more subjects from the subject database 110 which are similar to the received subject data. If there are more similar subjects, then return to operation 806 and select an additional subject. In an embodiment, additional subject data describes another property owner who owned 90 Breezy Acres, therefore returning to operation 806, and selecting the subject describing another property owner who owned 90 Breezy Acres. In an alternate embodiment, there are no additional subjects similar to the received subject data.

Operation 814 includes saving the received data to the subject database 110 as a new subject if the received subject data does not match any existing data records from the subject database 110. A source reliability score may additionally be determined and saved to the subject database 110 with the new subject data. In some embodiments, the source reliability score may be a default value.

Operation 816 includes returning the subject data to the server system 112. The subject data may comprise the received subject data and/or the subject data from the subject database 110 to which it matched. In one embodiment of the subject module 116, a professional pianist named Robert who used to live in a luxury loft in New York, noted that the acoustics in the loft greatly enhanced the sound of his piano and allowed him to compose numerous award-winning pieces. He shared his experiences with the SIO via a user device. The system identified Robert as a subject with a highly subjective experience of the property. It queried the subject database for subjects with similar experiences. As the experiences were unique, it did not find a match. Thus, it saved Robert's data as a new subject in the subject database. The source reliability score was based on Robert's credibility as a professional musician. This information was returned to the server system to add an artistic dimension to the property's valuation. In another embodiment, a yoga instructor, Lily, who lived in a serene lake house in Minnesota. Lily stated that the calm and peaceful environment of the house amplified her yoga practice and teaching. She shared this unique experience with the SIO. The SIO recognized Lily as a subject with an experience of the property. It queried the subject database for similar experiences but found no exact match due to the uniqueness of Lily's experiences. The SIO saved Lily's data as a new subject in the subject database, assigning a source reliability score based on Lily's credibility as a yoga instructor. This information was returned to the server system, enhancing the property's valuation with a spiritual and wellness perspective. In an additional embodiment, a painter, Alex, used to reside in a countryside cottage in France. Alex reported that the cottage's natural light and picturesque surroundings significantly inspired his painting. He communicated these experiences to the SIO. The system identified Alex as a subject with a highly subjective experience of the property. It queried the subject database for similar subjects but did not find a match due to the unique nature of Alex's experiences. The SIO saved Alex's data as a new subject in the subject database. The source reliability score was determined based on Alex's credibility as a painter. This data was returned to the server system, adding a unique artistic value to the property's overall valuation. In other embodiments, contributions to the story data of a property within the first system 102 can come from various stakeholders including builders, buyers, sellers, and renters. A builder, for instance, may offer rich insights into the construction process of a real estate, detailing specifics about the materials used, construction techniques employed, challenges faced, and the resolutions formulated. Information regarding any energy efficiency measures integrated during construction can also be supplied by the builder, all of which collectively influence the property's quality, durability, and ecological value. On the other hand, a buyer could provide subjective experience data, relaying their impressions about the property's aesthetics, the convenience of its location, neighborhood sentiment, and any personal emotional value they associate with the property. For instance, if a property evokes nostalgia reminding the buyer of their childhood home, this would add a layer to the property's sentimental value. Similarly, a seller can provide a historical perspective on the property, including information about any renovations, maintenance over the years, reasons behind their initial purchase, and their motivation to sell. Such data could significantly contribute to understanding the historical, sentimental, and strategic values of the property. Finally, a renter, through their lived experiences, can provide unique data about the practical convenience of the property, its impact on their lifestyle, and their interaction with the community. For example, the renter's account of how the property's proximity to a local park improved their quality of life would enhance the property's health and social value. Thus, these various data inputs collectively contribute to a comprehensive and multi-dimensional representation of a property's value within the first system 102.

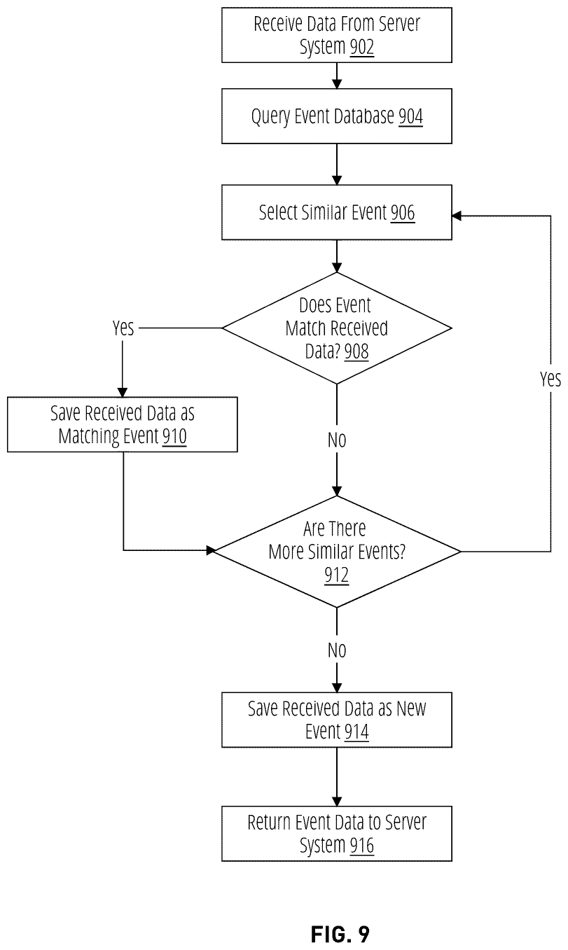

FIG. 9 is a flowchart illustrating an exemplary function of event module 118. The process begins with receiving, at operation 902, data from the server system 112. The data comprising an identified event data which may include data representing events or time related data such as a date and/or time of an event occurring at a parcel of real property or other location. Examples of events include purchase, construction, maintenance, deaths, births, weddings, and other events and/or occurrences. The data may also comprise a storm or other weather event, visits by individuals, etc. The event data may be comprised of any of a range of resolutions, such as a year, month, week, day, hour, minute, second, etc. and may further comprise a time period which may be segmented accordingly. For example, event data may comprise a date range during which a house was built on a specific property, such as at 90 Breezy Acres, which may have spanned a period of three months. Alternatively, event data may comprise a wedding occurring during 1.5 hours on a single day.

Operation 904 includes querying the event database 106 for event data which is similar to the received event data. For example, if one of the received event data elements comprises a description of the purchase of a property at 90 Breezy Acres, then query the event database 106 for data related to property purchases. If the received event data elements relate to a weather event, such as a tornado, then query the event database 106 for data related to tornados.

Operation 906 includes selecting an event from the event database 106 similar to the received data element. In an embodiment, the received data element comprising the description of a purchase of a property at 90 Breezy Acres, therefore selecting an event from the event database 106 describing a property purchase.

Operation 908 includes determining whether the selected event from the event database 106 matches the description in the received data element sufficient to confirm that both descriptions describe the same event. For example, matching the purchase of a property at 90 Breezy Acres may comprise comparing details from an account of the purchase to documents, such as a mortgage application, homeowners insurance contract, etc. If the events do not match, then check if there are more similar events. In an embodiment, the received data describes the purchase of 90 Breezy Acres by James Barker by a real property broker and the selected event is a purchase of 90 Breezy Acres as described by a mortgage application. The data is determined to be a match as the data on the mortgage application includes James Barker's name and personal identifiable information. Further corroboration is comprised by the matching timeframe, with the purchase being reported the same day as the date on the mortgage application.

Operation 910 includes saving the received data as matching the selected data to the event database 106. A source reliability score may additionally be determined and saved to the event database 106 with the matched data.

Operation 912 includes checking whether there are more events from the event database 106 which are similar to the received data element. If there are more similar events, then return to operation 906 and select an additional event. In an embodiment, an additional event describes the purchase of a residential home at 88 Breezy Acres. In an alternate embodiment, there are no additional events similar to the received event data.

Operation 914 includes saving the received data to the event database 106 as a new event if the received data element does not match any existing data records from the event database 106. A source reliability score may additionally be determined and saved to the event database 106 with the new event data. In some embodiments, the source reliability score may be a default value.

Operation 916 includes returning the event data to the server system 112. The event data may comprise the received event data and/or the event data from the event subject database 110 to which it matched.

In aspects of the present disclosure, the event module 118 in the first system 102 is capable of documenting and managing events related to the marketing and sale of a property. This process begins when the module receives data related to various aspects of a property's sale, such as, for example its listing, showings (either private or open house), its publications on MLS, Zillow, local newspapers, social media, and so forth. These events are then cross-referenced with existing data in the event database 106 to ensure consistency and accuracy. Following this, if an event, such as the property going under contract by a prospective buyer, closing of the property sale, the move-out of the seller or the move-in of the buyer, aligns with the received data, it is considered a match. This matched data, appended with a determined source reliability score, is saved in the event database 106. Conversely, if no match is found, the received data is categorized as a new event and is stored, typically with a default source reliability score. The module then returns the event data, whether matched or new, back to the server system 112, thus ensuring the continuous update and accuracy of the SIO related to the property.

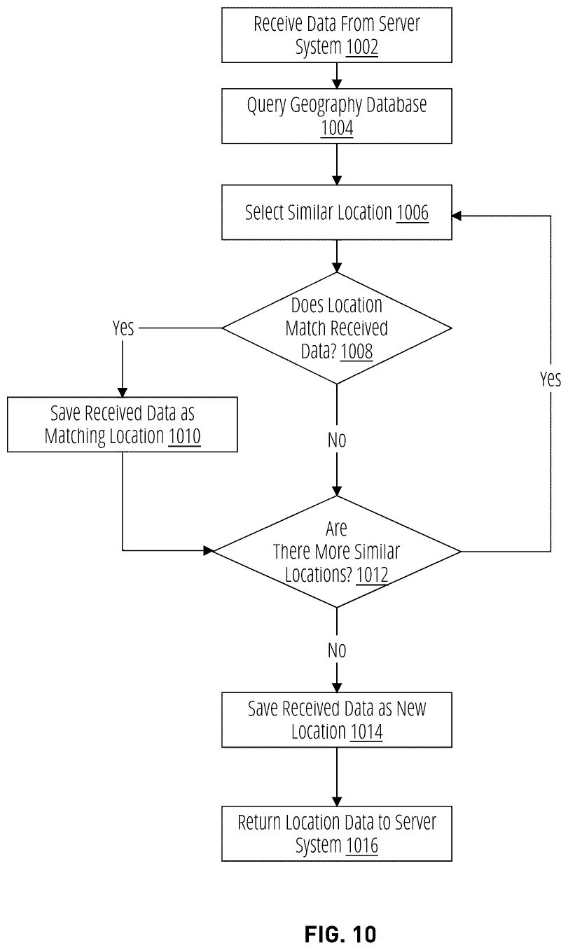

FIG. 10 is a flowchart illustrating an exemplary function of location module 120. The process begins with receiving, at operation 1002, data from the server system 112. The data comprises an identified location data which may include data representing locations such as countries, states, provinces, cities, towns, streets, buildings, GPS coordinates, etc. The location may alternatively refer to natural features such as a mountain, river, ocean, lake, etc. The location may be referred to by a plurality of names by different people, such as describing current and/or former owner's and/or businesses. In an ideal embodiment, the received location data comprising an address or other form of data defining a location such as GPS coordinates, referring to a specific property or other real property.

Operation 1004 includes querying the location database 108 for location data which is similar to the received location data. For example, selecting location data from the location database 108 related to real property located on or near to Breezy Acres, such as within one mile.

Operation 1006 includes selecting a location from the location database 108 similar to the received location data. In an embodiment, the received location data comprising the description of a raised ranch residential home at 90 Breezy Acres.

Operation 1008 includes determining whether the selected location from the location database 108 matches the description in the received location data sufficient to confirm that both descriptions describe the same location. For example, matching an address of 90 Breezy Acres to GPS coordinates which are located within the property boundaries of 90 Breezy Acres. Alternatively, matching 90 Breezy Acres to the current owner, James Barker. If the location descriptions do not match, then check if there are more similar locations.

Operation 1010 includes saving that the received location data matches the selected data to the location database 108. A source reliability score may additionally be determined and saved to the location database 108 with the matched data.

Operation 1012 includes checking whether there are more locations from the location database 108 which are similar to the received location data. If there are more similar locations, then return to operation 1006 and select an additional location. In an embodiment, an additional element describes a property currently owned by James Barker on Breezy Acres, therefore returning to operation 1006 and selecting the location describing the property owned by James Barker. In an alternate embodiment, there are no additional locations similar to the received location data.

Operation 1014 includes saving the received data to the location database 108 as a new location if the received location data does not match any existing data records from the location database 108. A source reliability score may additionally be determined and saved to the location database 108 with the new location data. In some embodiments, the source reliability score may be a default value.

Operation 1016 includes returning the location data to the server system 112. The location data may comprise the received location data and/or the location data from the location database 108 to which it matched.

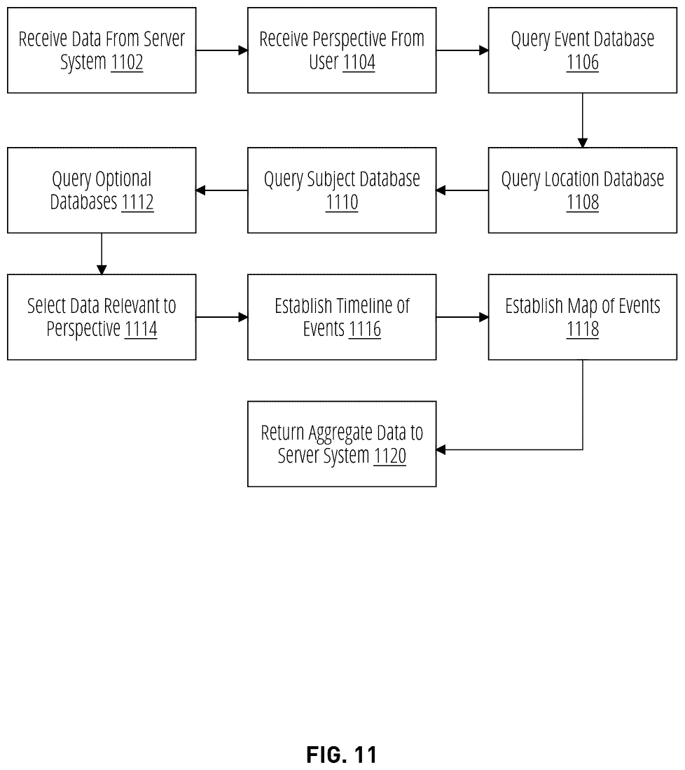

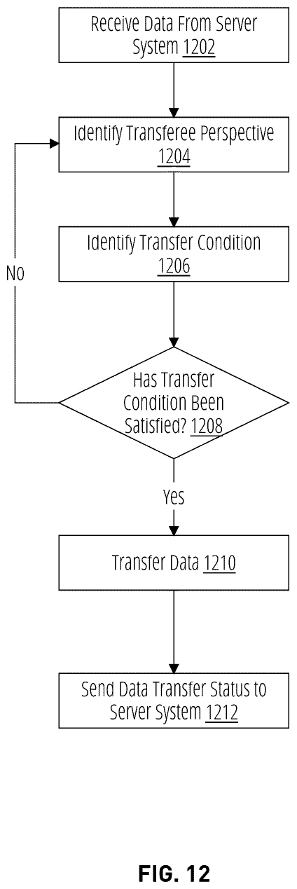

FIG. 11 is a flowchart illustrating an exemplary function of perspective module 122. The process begins with receiving, at operation 1102, data from the server system 112. The data comprises any of subject data, event, location, or subject data. In an ideal embodiment, the data comprises at least a location indicating or relating to a property or real property.

Operation 1104 includes receiving a perspective from a user. A perspective may comprise query parameters describing a story related to a property or real property. For example, the perspective may relate to a person and/or, the address of a location and/or an event. The perspective may further relate to a specific time period, a group of people, a location, etc. or any combination thereof. The perspective may relate to a person, a group of people, or a classification of people. For example, the perspective may relate to an owner of a specific property, such as James Barker who owns 90 Breezy Acres. Alternatively, the perspective may relate to a contractor who builds houses and may further relate to contractors involved in the construction and/or maintenance of a specific property, such as 90 Breezy Acres. Alternatively, the perspective may relate to visitors of a property or real property which may be a residential, commercial, or otherwise classified property or real property. Similarly, the perspective may relate to attendees of an event at a specific property, such as a wedding at 90 Breezy Acres, or alternatively a customer at a retail store. Likewise, the time detail may be general, encompassing a specific date, a longer period of time, such as a month or year, or may relate to a specific event, such as a construction, sale, or other event such as a wedding, birth, death, etc. Instead of relating to a specific property, a perspective may describe a class of real property, such as single family raised ranches, or grocery stores, etc. Likewise, the real property being grouped may relate to a geographic region or neighborhood. The perspective may further comprise a comparison, such as comparing a specific property or real property to other similar properties or real property, such as comparing characteristics of 90 Breezy Acres to other single family raised ranches within a one-mile radius of Breezy Acres.

Operation 1106 includes querying the event database 106 for time-based data related to the perspective received from the user. For example, retrieving data relating to the purchase of 90 Breezy Acres by James Barker. The data may comprise the start and end time of an event, such as the construction of the raised ranch house at 90 Breezy Acres.

Operation 1108 includes querying the location database 108 for location-based data related to the perspective received from the user. For example, retrieving data related to the property at 90 Breezy Acres. The details may comprise information about the structure, landscaping, site plan, etc.

Operation 1110 includes querying the subject database 110 for subject-based data related to the perspective received from the user. For example, retrieving data related to the owner of 90 Breezy Acres, James Barker. Alternatively, retrieving data related to a contractor who built 90 Breezy Acres. In other embodiments, the retrieved data may relate to a realtor, visitor, maintenance technician, etc. to 90 Breezy Acres.

Operation 1112 includes querying one or more optional databases which may store data relevant to the perspective received from the user, such as details relating to taxes or services rendered to a property or real property or the owner or other subject affiliated with a property or real property. Additional relevant data may comprise analysis of events, subjects, and/or locations by expert sources.

Operation 1114 includes selecting data relevant to the perspective received from the user. The data selection may comprise the use of an application of search criteria to filter the data. Alternatively, an algorithm may be used to identify the most relevant data and filter out irrelevant or less relevant data. Further, an algorithm may comprise a machine learning model including but not limited to a language model such as a generative pre-trained transformer.

Operation 1116 includes establishing a chronological timeline of relevant events from the data selected in response to the perspective received from a user. The timeline allowing each data reference to be referenced in the order in which the details it describes occurred or are relevant to a story relating to the perspective.

Operation 1118 includes establishing a map of relevant locations from the data selected in response to the perspective received from a user. The map allowing each data reference which can be associated with a location to be referenced relative to other data references to describe a physical space, either by generating a virtual representation of the location(s), compile a collection or composite of relevant images, or to create a description of relevant locations. In an embodiment, the map comprising a site plan and/or floor plan of a property or real property, such as 90 Breezy Acres. The map may further comprise areas of interest, such as where events occurred related to one or more subjects and/or perspectives.

Operation 1120 includes returning the aggregate data to the server system 112. The aggregate data comprising the components of a story and being organized at least by one or more of time and/or location. In an embodiment, the aggregate data comprising a narrative about the owner of 90 Breezy Acres, James Barker, specifically related to his ownership and/or time spent at 90 Breezy Acres. In another embodiment, the aggregate data may comprise a history of maintenance events, such as roof replacement and/or repairs, appliance repairs, etc. which were performed while James Baker owned 90 Breezy Acres. In another embodiment, the aggregate data may comprise a record of work performed by a contractor at 90 Breezy Acres. In another embodiment, the aggregate data may comprise a history of taxes and fees due and/or paid related to 90 Breezy Acres which may include property taxes, mortgage payments, homeowners' insurance, etc. and may further comprise utility bills and/or maintenance expenses.

In various embodiments, the perspective module 122 can compile and aggregate diverse data regarding property utilization, such as changes from owner-occupied residential use to rental, and eventually to light commercial use. Upon receiving location data from the server system 112 that pertains to a certain property, the perspective module 122 seeks out a user's perspective, which can outline a multifaceted narrative of the property's use history. For instance, a user might query the history of a property at 90 Breezy Acres. The perspective module 122 initiates database queries based on the user's perspective, drawing time-based, location-based, and subject-based data from the event database 106, location database 108, and subject database 110, respectively. These databases may house information on various aspects such as property purchase dates, occupancy statuses, zoning changes, and more. In the case of 90 Breezy Acres, it might extract initial data showing owner-occupied residential use. As the property's story unfolds, the module might gather further data showing a transition to rental use, represented perhaps by lease agreements or tenant data. Further along the timeline, data could suggest a rezoning application for the property and its subsequent approval, marking a shift from residential to light commercial use. Employing advanced algorithms, the perspective module 122 filters and selects data relevant to the user's perspective. With the selected data, it establishes a chronological timeline of events and a spatial map of relevant locations, effectively portraying the evolving use of the property over time. This aggregated data, translated into a compelling narrative, is returned to the server system 112. Thus, the module can provide a comprehensive, temporally arranged narrative of 90 Breezy Acres' transformation from an owner-occupied residence to a rental property, and ultimately to a light commercial establishment like a hair salon.

FIG. 12 is a flowchart illustrating an exemplary function of transfer module 124. The process begins with receiving at operation 1202, aggregated data comprising a story from the server system 112. The aggregate story may be from a perspective, such as a property owner, realtor, contractor, maintenance technician, etc. and may relate to a property or real property. In an embodiment, the story comprising a comprehensive history of property maintenance from the perspective of the current homeowner.

Operation 1204 includes identifying the perspective of the transferee to determine whether the aggregated data is relevant to the transferee. For example, a transferee may be a potential or contracted buyer of a property or real property. In another embodiment, the transferee perspective may be a contractor who is being hired to perform a renovation on a property. Alternatively, the transferee is a visitor, guest, customer, etc.

Operation 1206 includes identifying a transfer condition upon which the aggregated data or story may be made available to, shared with, or fully transferred to the transferee. Transfer conditions may include events such as a closing on a house finalizing the sale of the house. Alternatively, a transfer condition may be signing a contract to employ a contractor to perform renovations on the property, or a realtor to market and sell the property. In other embodiments, a transfer condition may be an attendee of a wedding or funeral. The transfer condition may relate to the type of information in the aggregate data/story or vice versa. In some embodiments, the story may be modified based upon the transfer condition.

Operation 1208 includes determining whether the transfer condition has been satisfied. For example, the transfer condition is satisfied for a transferee purchasing a property, if the closing documents have been signed. Alternatively, the transfer condition may require the digital filing of the sale documents and/or approval of the transaction by a third party. For an attendee of an event, the transfer condition may be met based on location data, such as the attendee being physically present on the premises during the event, such as may be determined by GPS coordinates, or other wireless communication and/or geolocation means, via a device on their person such as a user device 134.

Operation 1210 includes transferring the aggregate data when the transfer condition has been satisfied. The transfer of data may comprise sharing access to the data with the transferee. Alternatively, transferring data may refer to the transfer of custody and access, such as providing access to the data to the transferee, while removing access from the previous owner. In an embodiment, transferring access to the aggregate data comprising the historical maintenance records for a property and/or appliances and equipment on the property. In other embodiments, the aggregate data may comprise sharing data related to memories, experiences, or life events with attendees during an event such as a funeral, wedding, birthday, anniversary, etc.

Operation 1212 includes sending a data transfer status to the server system 112. The data transfer status may indicate that a data transfer has occurred and may further indicate what data has been transferred. Similarly, the data transfer status may indicate a change or updated access of the involved parties to the data which was transferred. In some embodiments, the data transfer status may indicate an error or other state such that a data transfer did not occur.

In some aspects of the present disclosure, the transfer module 124 embodies a system and method for managing and controlling the transfer of both public and private data related to the SIO in the context of real estate. It is designed to handle the delicate process of transitioning the ownership of data when properties change hands, while simultaneously maintaining the privacy and discretion of the individuals involved. One possible scenario involves the sale of a house. Public data such as the price of the last sale, address, property size, and style of home are commonly shared. Conversely, private data such as the number of occupants, wall color, specific room uses, interior/exterior modifications, utility costs, and a history of damage and repairs may not be publicly accessible but could be relevant to the potential buyer. Subjective data, such as personal memories, emotions, and experiences tied to the property by previous occupants also form part of the private data. The transfer module 124 is designed to handle such complexities by allowing previous owners to control what elements of the public and private data they wish to transfer during the sale, and how to partition the private data, choosing which parts to transfer and which to keep private. For instance, in some scenarios, a previous owner might opt to withhold certain subjective memories or emotions associated with the property, deeming them irrelevant or undesired by the new owner. Conversely, they might opt to selectively transfer private data such as maintenance records, damage history, repairs, or other private information about the property. In some cases, the sale of the house could be contingent upon the transfer of certain aspects of the private data. Consider a scenario where a seller insists that the house has never suffered flood damage. When the transfer module 124 facilitates the transfer of the property's SIO data to the buyer, an event flagged by the event module 118 might reveal that the basement had been previously flooded and sustained significant damage. In such cases, the discovery of this previously undisclosed information can lead to the sale being terminated or renegotiated. The data transferred via the transfer module 124, therefore, may play a role in ensuring the transparency and fairness of the transaction. The transfer module 124 begins the process by receiving aggregated data from the server system 112, which may include a comprehensive story about the property from various perspectives such as a homeowner, realtor, contractor, or maintenance technician. It identifies the perspective of the transferee to ascertain the relevance of the aggregated data to the transferee. This transferee could be a potential buyer, a contracted buyer, a contractor hired for renovations, or even a visitor. The module then identifies a transfer condition upon which the aggregated data may be shared, made available, or fully transferred to the transferee. This condition could be a formal event such as the closing of a house sale or the signing of a renovation contract. Once the transfer condition is determined, the module checks if it has been satisfied. Upon satisfaction of the transfer condition, the module then facilitates the transfer of the aggregated data. The process concludes by sending a data transfer status to the server system 112, indicating that the data transfer has occurred, and potentially providing additional details about what data has been transferred. In some embodiments, public and private sharing of information has many uses outside of real property, land and property and can be used for any transfer of private or sensitive information in any system, object, or subject.

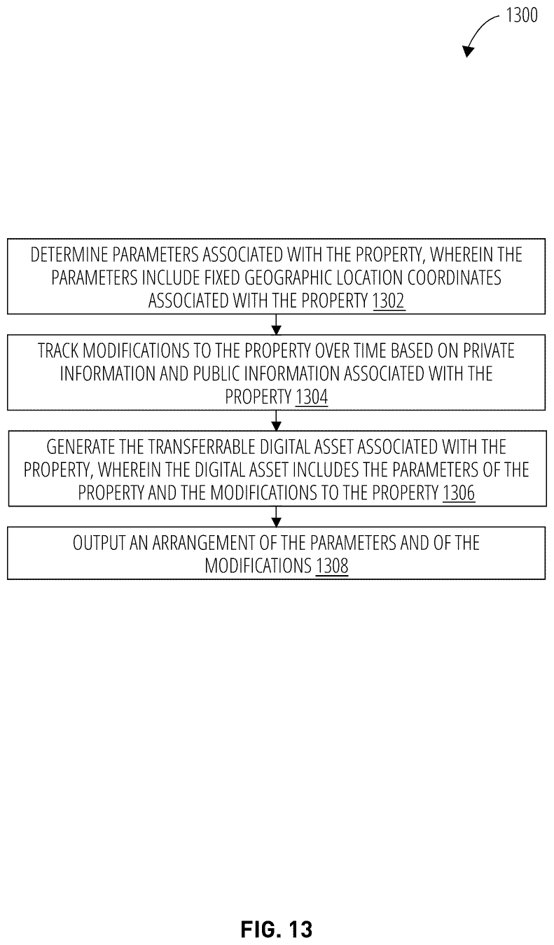

FIG. 13 is a flowchart illustrating an example of a process 1300 for aggregation and transfer of property data. The process 1300 can generate a transferrable digital asset associated with property for aggregation and transfer of the property data. The process is performed by using a property story generation system, which may include, for instance, first system 102, server system 112, second system 126, user device 134, system(s) that perform any of the process(es) illustrated in the flowcharts of FIGS. 6-12, a computing system and/or computing device with at least one processor performing instructions stored in at least one memory (and/or in a non-transitory computer-readable storage medium), a system, and apparatus, or a combination thereof. In some examples, the property can be physical and/or real property. For example, the property can be a plot of land and/or a dwelling on a plot of land. In some examples, the property can be virtual property. For example, virtual property can be real property that exists in a digital medium. For example, a plot of land in a digital world or a particular location in the metaverse.

At operation 1302, the property story generation system determines parameters associated with the property. The parameters may include fixed geographic location coordinates associated with the property. In some examples, the geographic location coordinates are Global Navigation Satellite System (GNSS) coordinates. In some examples, the fixed geographic location coordinates are associated with a boundary of the property. In some examples, the fixed geographic location coordinates are also mapped through time. For example, boundaries of a property or land may evolve over time. These changes can be tracked and annotated in real time. In some examples, the parameters include materials used in association with the property. For example, the parameters can include wood in association with a frame of a house of the property. In some examples, at least one modification of the modifications to the property is a modification to the materials used in association with the property. For example, owners may remodel the home and change materials of fixtures or other parts of the home, such as changing a granite counter to a marble counter. In some examples, the parameters further include information of human experiences associated with the fixed geographic location coordinates. For example, the information can be related to who built the home, events that occurred at the property, stories of people that lived there, etc.

At operation 1304, the property story generation system tracks modifications to the property over time based on private information and public information associated with the property. For example, public information can include property tax records, sale records, listings (e.g., on MLS, Zillow, Realtor.com, etc.), pictures, newspaper articles, etc. Private information can include individual narratives passed by word of mouth or text, personal documents, maintenance records, damage history, repairs, etc. In some examples, an owner of the transferrable digital asset can decide what information or data is kept private. In some examples, the owner can decide which elements of the information or data is transferred upon transfer of the transferrable digital asset.

At operation 1306, the property story generation system generates the transferrable digital asset associated with the property. The digital asset may include the parameters of the property and the modifications to the property. In some examples, the digital asset has an ownership attribute, and the ownership attribute can be modified to transfer ownership of the digital asset from a first owner to a second owner. Examples of the digital asset include data elements (e.g., SIO data elements) discussed herein or aggregations thereof. In some examples, the digital asset can be transferred along with transfer of title for property (e.g., land and/or estate), or separately from the transfer of title. In some examples, transfer of title from a first party to a second party can automatically cause (e.g., through smart contract(s) and/or other systems for automatically triggering an action in response to verifying the occurrence of a condition) transfer of the digital asset from the first party to the second party. Similarly, in some examples, transfer of digital asset from a first party to a second party can automatically cause (e.g., through smart contract(s) and/or other systems for automatically triggering an action in response to verifying the occurrence of a condition) transfer of the title from the first party to the second party. Ownership or transfer of the digital asset can refer to ownership or transfer of unique access to one or more nodes (e.g., data elements) that is associated to correlating attribute nodes. In some instances, a person that creates an SIO may not actually own the object that the SIO references. For example, a person may take a photo of a castle but might not own the castle. In these instances, the person would own the photo but not the castle. Similarly, the person can own their impression (e.g., the photo itself) and/or the SIO relationship to the main object (e.g., the photo being of the castle). Additionally, the owner of the object might not have ownership over the SIO, but the relationship between the SIO and the object itself can still exist. For example, the owner of the castle may sell the castle to a new owner, but neither the owner nor the new owner would have ownership of the photo. This creates a title and agency of the social identity of each property and the individually owned pieces of content that are associated with each defined property.

At operation 1308, the property story generation system outputs an arrangement of the parameters and of the modifications. For example, the arrangement of the parameters and of the modifications may be assembled to form a story. The arrangement may, for example, be displayed as a timeline, a graph, an infographic, a narrative, etc.

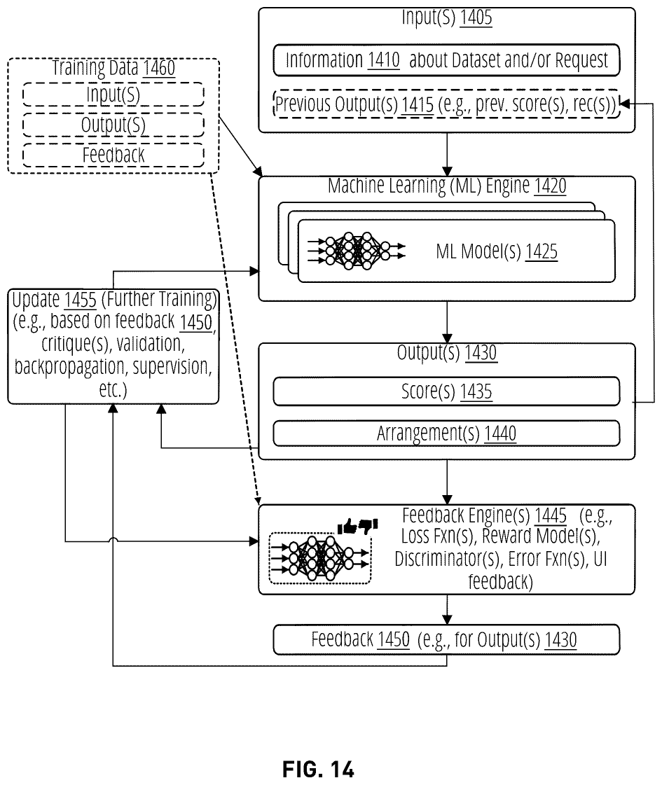

FIG. 14 is a block diagram illustrating an example of a machine learning system 1400 for training, use of, and/or updating of one or more machine learning model(s) 1425 that are used to generate score(s) 1435 and/or arrangement(s) 1440. The machine learning (ML) system 1400 includes an ML engine 1420 that generates, trains, uses, and/or updates one or more ML model(s) 1425. In some examples, the property story generation system, first system 102, second system 126, and/or server system 112 include the ML system 1400, the ML engine 1420, the ML model(s) 1425, and/or the feedback engine(s) 1445, or vice versa.

The ML model(s) 1425 can include, for instance, one or more neural network(s) (NN(s)), one or more convolutional NN(s) (CNN(s)), one or more time delay NN(s) (TDNN(s)), one or more deep network(s) (DN(s)), one or more autoencoder(s) (AE(s)), one or more variational autoencoder(s) (VAE(s)), one or more deep belief net(s) (DBN(s)), one or more recurrent NN(s) (RNN(s)), one or more generative adversarial network(s) (GAN(s)), one or more conditional GAN(s) (cGAN(s)), one or more feed-forward network(s), one or more network(s) having fully connected layers, one or more support vector machine(s) (SVM(s)), one or more random forest(s) (RF), one or more computer vision (CV) system(s), one or more autoregressive (AR) model(s), one or more Sequence-to-Sequence (Seq2Seq) model(s), one or more large language model(s) (LLM(s)), one or more deep learning system(s), one or more classifier(s), one or more transformer(s), or a combination thereof. In examples where the ML model(s) 1425 include LLMs, the LLMs can include, for instance, a Generative Pre-Trained Transformer (GPT) (e.g., GPT-2, GPT-3, GPT-3.5, GPT-4, etc.), DaVinci or a variant thereof, an LLM using Massachusetts Institute of Technology (MIT)® langchain, Pathways Language Model (PaLM), Large Language Model Meta® AI (LLaMA), Language Model for Dialogue Applications (LaMDA), Bidirectional Encoder Representations from Transformers (BERT), Falcon (e.g., 40B, 7B, 1B), Orca, Phi-1, StableLM, variant(s) of any of the previously-listed LLMs, or a combination thereof.

Within FIG. 14, a graphic representing the ML model(s) 1425 illustrates a set of circles connected to one another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. An ML model can include more or fewer hidden layers than the two illustrated, but includes at least one hidden layer. In some examples, the layers and/or nodes represent interconnected filters, and information associated with the filters is shared among the different layers with each layer retaining information as the information is processed. The lines between nodes can represent node-to-node interconnections along which information is shared. The lines between nodes can also represent weights (e.g., numeric weights) between nodes, which can be tuned, updated, added, and/or removed as the ML model(s) 1425 are trained and/or updated. In some cases, certain nodes (e.g., nodes of a hidden layer) can transform the information of each input node by applying activation functions (e.g., filters) to this information, for instance applying convolutional functions, downscaling, upscaling, data transformation, and/or any other suitable functions.

In some examples, the ML model(s) 1425 can include a feed-forward network, in which case there are no feedback connections where outputs of the network are fed back into itself. In some cases, the ML model(s) 1425 can include a recurrent neural network, which can have loops that allow information to be carried across nodes while reading in input. In some cases, the network can include a convolutional neural network, which may not link every node in one layer to every other node in the next layer.

One or more input(s) 1405 can be provided to the ML model(s) 1425. The ML model(s) 1425 can be trained by the ML engine 1420 (e.g., based on training data 1460) to generate one or more output(s) 1430. In some examples, the input(s) 1405 include information 1410. The information 1410 can include, for instance, source data, event data, location data, subject data, etc., or a combination thereof.

The output(s) 1430 that ML model(s) 1425 generate by processing the input(s) 1405 (e.g., the information 1410 and/or the previous output(s) 1415) can include score(s) 1435 and/or arrangement(s) 1440. The score(s) 1435 can include, for instance, “Historocity” scores, trustworthiness scores, reliability scores, source scores, etc. The arrangement(s) 1440 can include, for instance, an estimate of an object's significance, whether the data source is trustworthy, estimated value for the property, etc. In some embodiments, the arrangement is a transferrable data asset including the score(s) 1435 and other data, such as the estimate of the object's significance, determinations to data source trustworthiness, estimated values of the property, historical information related to the property, etc. The ML model(s) 1425 can generate the score(s) 1435 based on the information 1410 and/or other types of input(s) 1405 (e.g., previous output(s) 1415). In some examples, the score(s) 1435 can be used as part of the input(s) 1405 to the ML model(s) 1425 (e.g., as part of previous output(s) 1415) for generating the arrangement(s) 1440, for identifying a further score(s) 1435, and/or for generating other output(s) 1430. In some examples, at least some of the previous output(s) 1415 in the input(s) 1405 represent previously-identified score(s) that are input into the ML model(s) 1425 to identify the score(s) 1435, the arrangement(s) 1440, and/or other output(s) 1430. In some examples, based on receipt of the input(s) 1405, the ML model(s) 1425 can select the output(s) 1430 from a list of possible outputs, for instance by ranking the list of possible outputs by likelihood, probability, and/or confidence based on the input(s) 1405. In some examples, based on receipt of the input(s) 1405, the ML model(s) 1425 can identify the output(s) 1430 at least in part using generative artificial intelligence (AI) content generation techniques, for instance using an LLM to generate custom text and/or graphics identifying the output(s) 1430.

In some examples, the ML system repeats the process illustrated in FIG. 14 multiple times to generate the output(s) 1430 in multiple passes, using some of the output(s) 1430 from earlier passes as some of the input(s) 1405 in later passes (e.g., as some of the previous output(s) 1415). For instance, in a first illustrative example, in a first pass, the ML model(s) 1425 can identify the score(s) 1435 based on input of the information 1410 into the ML model(s) 1425. In a second pass, the ML model(s) 1425 can identify the arrangement(s) 1440 based on input of the information 1410 and the previous output(s) 1415 (that includes the score(s) 1435 from the first pass) into the ML model(s) 1425.

In some examples, the ML system includes one or more feedback engine(s) 1445 that generate and/or provide feedback 1450 about the output(s) 1430. In some examples, the feedback 1450 indicates how well the output(s) 1430 align to corresponding expected output(s), how well the output(s) 1430 serve their intended purpose, or a combination thereof. In some examples, the feedback engine(s) 1445 include loss function(s), reward model(s) (e.g., other ML model(s) that are used to score the output(s) 1430), discriminator(s), error function(s) (e.g., in back-propagation), user interface feedback received via a user interface from a user, or a combination thereof. In some examples, the feedback 1450 can include one or more alignment score(s) that score a level of alignment between the output(s) 1430 and the expected output(s) and/or intended purpose.

The ML engine 1420 of the ML system can update (further train) the ML model(s) 1425 based on the feedback 1450 to perform an update 1455 (e.g., further training) of the ML model(s) 1425 based on the feedback 1450. In some examples, the feedback 1450 includes positive feedback, for instance indicating that the output(s) 1430 closely align with expected output(s) and/or that the output(s) 1430 serve their intended purpose. In some examples, the feedback 1450 includes negative feedback, for instance indicating a mismatch between the output(s) 1430 and the expected output(s), and/or that the output(s) 1430 do not serve their intended purpose. For instance, high amounts of loss and/or error (e.g., exceeding a threshold) can be interpreted as negative feedback, while low amounts of loss and/or error (e.g., less than a threshold) can be interpreted as positive feedback. Similarly, high amounts of alignment (e.g., exceeding a threshold) can be interpreted as positive feedback, while low amounts of alignment (e.g., less than a threshold) can be interpreted as negative feedback.

In response to positive feedback in the feedback 1450, the ML engine 1420 can perform the update 1455 to update the ML model(s) 1425 to strengthen and/or reinforce weights (and/or connections and/or hyperparameters) associated with generation of the output(s) 1430 to encourage the ML engine 1420 to generate similar output(s) 1430 given similar input(s) 1405. In this way, the update 1455 can improve the ML model(s) 1425 itself by improving the accuracy of the ML model(s) 1425 in generating output(s) 1430 that are similarly accurate given similar input(s) 1405. In response to negative feedback in the feedback 1450, the ML engine 1420 can perform the update 1455 to update the ML model(s) 1425 to weaken and/or remove weights (and/or connections and/or hyperparameters) associated with generation of the output(s) 1430 to discourage the ML engine 1420 from generating similar output(s) 1430 given similar input(s) 1405. In this way, the update 1455 can improve the ML model(s) 1425 itself by improving the accuracy of the ML model(s) 1425 in generating output(s) 1430 are more accurate given similar input(s) 1405. In some examples, for instance, the update 1455 can improve the accuracy of the ML model(s) 1425 in generating output(s) 1430 by reducing false positive(s) and/or false negative(s) in the output(s) 1430.

For instance, here, if the score(s) 1435 and/or arrangement(s) 1440 are corroborated, the corroboration can be interpreted as feedback 1450 that is positive (e.g., positive feedback). For instance, here, if the score(s) 1435 and/or arrangement(s) 1440 are inconsistent with other records, the inconsistency can be interpreted as feedback 1450 that is negative (e.g., negative feedback). Either way, the update 1455 can improve the machine learning system 1400 and the overall system by improving the consistency with which the corroboration or verification is successful.

In some examples, the ML engine 1420 can also perform an initial training of the ML model(s) 1425 before the ML model(s) 1425 are used to generate the output(s) 1430 based on the input(s) 1405. During the initial training, the ML engine 1420 can train the ML model(s) 1425 based on training data 1460. In some examples, the training data 1460 includes examples of input(s) (of any input types discussed with respect to the input(s) 1405), output(s) (of any output types discussed with respect to the output(s) 1430), and/or feedback (of any feedback types discussed with respect to the feedback 1450). In some cases, positive feedback in the training data 1460 can be used to perform positive training, to encourage the ML model(s) 1425 to generate output(s) similar to the output(s) in the training data given input of the corresponding input(s) in the training data. In some cases, negative feedback in the training data 1460 can be used to perform negative training, to discourage the ML model(s) 1425 from generate output(s) similar to the output(s) in the training data given input of the corresponding input(s) in the training data. In some examples, the training of the ML model(s) 1425 (e.g., the initial training with the training data 1460, update(s) 1455 based on the feedback 1450, and/or other modification(s)) can include fine-tuning of the ML model(s) 1425, retraining of the ML model(s) 1425, or a combination thereof.

In some examples, the ML model(s) 1425 can include an ensemble of multiple ML models, and the ML engine 1420 can curate and manage the ML model(s) 1425 in the ensemble. The ensemble can include ML model(s) 1425 that are different from one another to produce different respective outputs, which the ML engine 1420 can average (e.g., mean, median, and/or mode) to identify the output(s) 1430. In some examples, the ML engine 1420 can calculate the standard deviation of the respective outputs of the different ML model(s) 1425 in the ensemble to identify a level of confidence in the output(s) 1430. In some examples, the standard deviation can have an inverse relationship with confidence. For instance, if the respective outputs of the different ML model(s) 1425 are very different from one another (and thus have a high standard deviation above a threshold), the confidence that the output(s) 1430 are accurate may be low (e.g., below a threshold). On the other hand, if the respective outputs of the different ML model(s) 1425 are equal or very similar to one another (and thus have a low standard deviation below a threshold), the confidence that the output(s) 1430 are accurate may be high (e.g., above a threshold). In some examples, different ML models(s) 1425 in the ensemble can include different types of models. For instance, in some examples, an ensemble can include a NN and a SVM that are both trained to process the input(s) 1405 to generate at least a subset of the output(s) 1430. In some examples, the ensemble may include different ML model(s) 1425 that are trained to process different inputs of the input(s) 1405 and/or to generate different outputs of the output(s) 1430. For instance, in some examples, a first model (or set of models) can process the input(s) 1405 to generate the score(s) 1435, while a second model (or set of models) can process the input(s) 1405 to generate the arrangement(s) 1440. In some examples, the ML engine 1420 can choose specific ML model(s) 1425 to be included in the ensemble because the chosen ML model(s) 1425 are effective at accurately processing particular types of input(s) 1405, are effective at accurately generating particular types of output(s) 1430, are generally accurate, process input(s) 1405 quickly, generate output(s) 1430 quickly, are computationally efficient, have higher or lower degrees of uncertainty than other models in the ensemble, or a combination thereof.

In some examples, one or more of the ML model(s) 1425 can be initialized with weights, connections, and/or hyperparameters that are selected randomly. This can be referred to as random initialization. These weights, connections, and/or hyperparameters are modified over time through training (e.g., initial training with the training data 1460 and/or update(s) 1455 based on the feedback 1450), but the random initialization can still influence the way the ML model(s) 1425 process data, and thus can still cause different ML model(s) 1425 (with different random initializations) to produce different output(s) 1430. Thus, in some examples, different ML model(s) 1425 in an ensemble can have different random initializations.

As an ML model (of the ML model(s) 1425) is trained (e.g., along the initial training with the training data 1460, update(s) 1455 based on the feedback 1450, and/or other modification(s)), different versions of the ML model at different stages of training can be referred to as checkpoints. In some examples, after each new update to a model (e.g., update 1455) generates a new checkpoint for the model, the ML engine 1420 tests the new checkpoint (e.g., against testing data and/or validation data where the correct output(s) are known) to identify whether the new checkpoint improves over older checkpoints or not, and/or if the new checkpoint introduces new errors (e.g., false positive(s) and/or false negative(s)). This testing can be referred to as checkpoint benchmark scoring. In some examples, in checkpoint benchmark scoring, the ML engine 1420 produces a benchmark score for one or more checkpoint(s) of one or more ML model(s) 1425, and keeps the checkpoint(s) that have the best (e.g., highest or lowest) benchmark scores in the ensemble. In some examples, if a new checkpoint is worse than an older checkpoint, the ML engine 1420 can revert to the older checkpoint. The benchmark score for a can represent a level of accuracy of the checkpoint and/or number of errors (e.g., false positive or false negative) by the checkpoint during the testing (e.g., against the testing data and/or the validation data). In some examples, an ensemble of the ML model(s) 1425 can include multiple checkpoints of the same ML model.

In some examples, the ML model(s) 1425 can be modified, either through the initial training (with the training data 1460), an update 1455 based on the feedback 1450, or another modification to introduce randomness, variability, and/or uncertainty into an ensemble of the ML model(s) 1425. In some examples, such modification(s) to the ML model(s) 1425 can include dropout (e.g., Monte Carlo dropout), in which one or more weights or connections are selected at random and removed. In some examples, dropout can also be performed during inference, for instance to modify the output(s) 1430 generated by the ML model(s) 1425. The term Bayesian Machine Learning (BML) can refer to random dropout, random initialization, and/or other randomization-based modifications to the ML model(s) 1425. In some examples, the modification(s) to the ML model(s) 1425 can include a hyperparameter search and/or adjustment of hyperparameters. The hyperparameter search can involve training and/or updating different ML models 1425 with different values for hyperparameters and evaluating the relative performance of the ML models 1425 (e.g., against (e.g., against testing data and/or validation data where the correct output(s) are known) to identify which of the ML models 1425 performs best. Hyperparameters can include, for instance, temperature (e.g., influencing level creativity and/or randomness), top P (e.g., influencing level creativity and/or randomness), frequency penalty (e.g., to prevent repetitive language between one of the output(s) 1430 and another), presence penalty (e.g., to encourage the ML model(s) 1425 to introduce new data in the output(s) 1430), other parameters or settings, or a combination thereof.

In some examples, the ML engine 1420 can perform retrieval-augmented generation (RAG) using the model(s) 1425. For instance, in some examples, the ML engine 1420 can pre-process the input(s) 1405 by retrieving additional information from one or more data store(s) (e.g., any of the databases and/or other data structures discussed herein) and using the additional information to enhance the input(s) 1405 before the input(s) 1405 are processed by the ML model(s) 1425 to generate the output(s) 1430. For instance, in some examples, the enhanced versions of the input(s) 1405 can include the additional information that the ML engine 1420 retrieved from the from one or more data store(s). In some examples, this RAG process provides the ML model(s) 1425 with more relevant information, allowing the ML model(s) 1425 to generate more accurate and/or personalized output(s) 1430.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method for generating a transferrable digital asset associated with property, the method comprising:
determining parameters associated with the property, wherein the parameters include fixed geographic location coordinates associated with the property;
tracking modifications to the property over time based on private information and public information associated with the property;
generating the transferrable digital asset associated with the property, wherein the digital asset includes the parameters of the property and the modifications to the property; and
outputting an arrangement of the parameters and of the modifications.

2. The method of claim 1, wherein the digital asset has an ownership attribute, and wherein the ownership attribute can be modified to transfer ownership of the digital asset from a first owner to a second owner.

3. The method of claim 1, wherein the parameters include materials used in association with the property, and wherein at least one modification of the modifications to the property is a modification to the materials used in association with the property.

4. The method of claim 1, wherein the geographic location coordinates are Global Navigation Satellite System (GNSS) coordinates.

5. The method of claim 1, wherein the fixed geographic location coordinates are associated with a boundary of the property.

6. The method of claim 1, wherein the parameters further include information of human experiences associated with the fixed geographic location coordinates.

7. The method of claim 1, wherein the fixed geographic location coordinates are also mapped through time.

8. The method of claim 1, wherein the property is real property.

9. The method of claim 1, wherein the property is virtual property.

10. A system for generating a transferrable digital asset associated with property, the system comprising:
memory; and
a processor that executes instructions in memory, wherein execution of the instructions by the processor:
determine parameters associated with the property, wherein the parameters include fixed geographic location coordinates associated with the property;
track modifications to the property over time based on private information and public information associated with the property;
generate the transferrable digital asset associated with the property, wherein the digital asset includes the parameters of the property and the modifications to the property; and
output an arrangement of the parameters and of the modifications.

11. The system of claim 8, wherein the digital asset has an ownership attribute, and wherein the ownership attribute can be modified to transfer ownership of the digital asset from a first owner to a second owner.

12. The system of claim 8, wherein the parameters include materials used in association with the property, and wherein at least one modification of the modifications to the property is a modification to the materials used in association with the property.

13. The system of claim 8, wherein the geographic location coordinates are Global Navigation Satellite System (GNSS) coordinates.

14. The system of claim 8, wherein the fixed geographic location coordinates are associated with a boundary of the property.

15. The system of claim 8, wherein the parameters further include information of human experiences associated with the fixed geographic location coordinates.

16. The system of claim 8, wherein the fixed geographic location coordinates are also mapped through time.

17. A non-transitory computer-readable storage medium, having embodied thereon a program executable by a processor to perform a method for generating a transferrable digital asset associated with property, the method comprising:
determining parameters associated with the property, wherein the parameters include fixed geographic location coordinates associated with the property;
tracking modifications to the property over time based on private information and public information associated with the property;
generating the transferrable digital asset associated with the property, wherein the digital asset includes the parameters of the property and the modifications to the property; and
outputting an arrangement of the parameters and of the modifications.

18. The non-transitory computer-readable storage medium of claim 15, wherein the digital asset has an ownership attribute, and wherein the ownership attribute can be modified to transfer ownership of the digital asset from a first owner to a second owner.

19. The non-transitory computer-readable storage medium of claim 15, wherein the parameters include materials used in association with the property, and wherein at least one modification of the modifications to the property is a modification to the materials used in association with the property.

20. The non-transitory computer-readable storage medium of claim 15, wherein the geographic location coordinates are Global Navigation Satellite System (GNSS) coordinates.
